(19) United States
(12) Patent Application Publication
(10) Pub. No.: US 2007/0150578 A1
(43) Pub. Date: Jun. 28, 2007

(54) MANAGING A REMOTE DEVICE

(75) Inventors: Marcio Cravo de Almeida, Rio de Janeiro (BR); Nelson Alves Da Silva Filho, Rio de Janeiro (BR); Agostinho de Arruda Villela, Rio de Janeiro (BR); Andre Araujo Da Fosenca, Rio de Janeiro (BR); Marcelo Salim Da Silva, Rio de Janeiro (BR)

Correspondence Address: FISH & RICHARDSON PC, P.O. BOX 1022, MINNEAPOLIS, MN, 55440-1022, US

(73) Assignee: Automatos, Inc., a Massachusetts corporation

(21) Appl. No.: 11/684,315

(22) Filed: Mar. 9, 2007

Related U.S. Application Data
(63) Continuation of application No. 09/954,819, filed on Sep. 18, 2001.

(51) Int. Cl. G06F 15/173

(52) U.S. Cl. 709/223

(57) ABSTRACT

An agent obtains data from a device by receiving a plug-in containing system calls for obtaining the data from the device, loading the plug-in into the agent, obtaining the data from the device using the system calls, and transmitting the data over an external network using one or more of a plurality of protocols. The data is provided to a client by formatting the data, and making the formatted data accessible to a client via the external network.

### TECHNICAL FIELD

This invention relates to managing a remote device, including obtaining data from the remote device and presenting the data to a client device.

### BACKGROUND

Today's rapidly changing information technology (IT) environment has created significant obstacles, or “pain points” for corporate IT managers worldwide. Corporations and their IT departments are faced with the daunting task of managing the sheer growth in the size and complexity of their internal and external networks, as well as the rapid integration of new Web-based applications with legacy systems. This creates the necessity of highly trained and specialized IT staff, to have the necessary intelligence to manage so many different systems that make up the internal and external network. When combined with an overall shortage of IT talent in the marketplace, more cautious IT spending, and a generally insufficient level of specialized training within existing IT staffs, the need for scalable third party management solutions has become urgent.

Third party management solutions can sometimes bring more problems than solutions. The implementation cycle associated with management tools are huge. The costs associated are also more than many IT departments had planned. When combined with the need for specialized team to work the third party tools, IT departments need to look elsewhere, creating a need for outsourced IT management services, which can deliver a continuous automated IT management solution, using the Internet, for example.

Firewalls and other internal network security systems can prevent third party remote access to data stored in devices on an internal network. This can be problematic, particularly for network administrators who cannot access the internal network, but who need to obtain information about one or more devices on the internal network. Systems currently exist which allow such a device to send pre-selected status information to a remote device via electronic mail (e-mail). These existing systems, however, do not provide enough flexibility for some users.

### SUMMARY

In general, in one aspect, the invention is directed to obtaining data from a device using an agent. This aspect includes receiving a plug-in containing system calls for obtaining the data from the device, loading the plug-in into the agent, obtaining the data from the device using the system calls, and transmitting the data over an external network using one or more of a plurality of protocols. This aspect may include one or more of the following features.

The agent may include shared libraries containing system calls for obtaining other data from the device. The shared libraries may be loaded into the agent when the plug-in is loaded. The data may be obtained from the device periodically, such as every minute. The plurality of protocols may include simple mail transfer protocol (SMTP), hyper text transfer protocol (HTTP), and secure sockets layer (SSL) protocol. Data transmission may be effected using at least one of a proxy and socket.

The agent may reside on an internal network that includes the device. A machine may be selected on the internal network to transmit the data over the external network. The external network may include the Internet. The agent may reside on the device. The agent may reside on a machine located on the internal network that is not the device. The network may include a network device located on the internal network and the agent may reside on a server that is also on the internal network. The data may relate to one or more of the following: a processor on the device, memory on the device, a hard drive on the device, the internal network on which the device is located, and software installed on the device.

In general, in another aspect, the invention is directed to providing, to a client, data that was obtained by an agent from a remote device on an internal network. This aspect includes receiving the data via an external network, at least some of the data being received periodically, formatting the data, and making the formatted data accessible to a client via the external network. This aspect may include one or more of the following features.

Formatting the data may include generating a report based on the data. The report may be a natural language report. Formatting the data may include generating a display based on the data and updating the display periodically as new data is received periodically via the external network. The data may be received every minute. Formatting the data may include determining if the data indicates that an operational parameter of the device exceeds a preset limit and generating a report to a client indicating that the operational parameter exceeds the preset limit.

The external network may include the Internet. Making the formatted data accessible to the client may include providing a World Wide Web site through which the data can be accessed by the client. The formatted data may be made accessible to the client using wireless application protocol.

### DESCRIPTION OF THE DRAWINGS

FIG. 1 is a view of a network that includes an internal network having devices to be monitored by an agent.

FIGS. 2 to 9 and 28 to 41 show installation screens for the agent, including the relay portion of the agent.

FIG. 10 is a flowchart showing a process for monitoring a device on the internal network.

FIG. 11 is a flowchart showing a process for providing data from a monitored device to a user.

FIGS. 12 to 26 show Web pages for viewing the data from the monitored device.

FIG. 27 shows a computer on which the processes of FIGS. 10 and/or 11 may be implemented.

FIGS. 42 to 51 shows a cellular telephone for viewing data obtained by the agent.

FIGS. 52a, 52b and 53 show Web pages for enrolling in a service in order to download the agent.

### DESCRIPTION

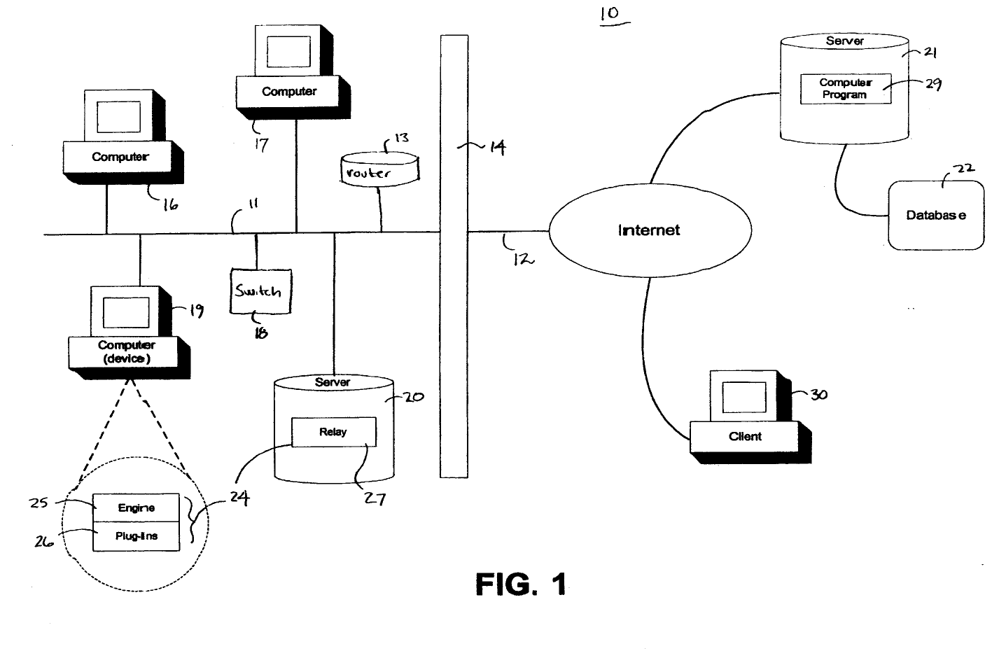

FIG. 1 shows a network system 10. Network system 10 includes an internal network, such as a local area network (LAN), and an external network, such as the Internet. Internal network 11 is segregated from external network 12 via a firewall 14. Firewall 14 allows messages, such as e-mail, to be exchanged between devices (e.g., computers) on internal network 11 and external network 12. However, firewall 14 does not permit devices on external network 12 to directly access data stored on internal network 11.

Internal network 11 contains several devices. These devices may be computers with network interface cards, including servers and desktop computers, and/or network peripherals, such as routers, hubs or switches. Internal network 11 includes three desktop computers 16, 17 and 19, server 20, router 13 and switch 18. Other devices may also be included in addition to, or instead of, these devices.

External network 12 contains a server 21, which has access to a database 22. In this embodiment, server 21 is one or more World Wide Web (or simply “Web”) servers that are capable of receiving data, storing the data in database 22, processing the data, and hosting a Web site that makes the processed data accessible to client devices, directly or indirectly via the Internet. The details of the processing performed by server 21 and the Web site hosted by server 21 are provided below.

A computer program, known as an “agent”, is installed on a device, such as computer 19, on internal network 11. The agent permits a remote client device to manage computer 19 and to monitor computer 19 and other devices on internal network 11. This is done through the use of communications provided from the agent to server 21. The communications may be transmitted via e-mail using simple mail transfer protocol (SMTP), hyper text transfer protocol (HTTP) or secure sockets layer (SSL) protocol. SSL is a protocol developed by Netscape® for transmitting private documents over the Internet. SSL works by using a public key to encrypt data that is transferred over an established SSL connection. Additionally, the communications might have to have additional provisions for crossing through a firewall, such as supporting authenticated proxies and the like. More than one agent may be installed on a single network.

Each agent 24 is comprised of three core software components: an engine 25, one or more plug-ins 26, and a relay 27. These core components may run on the same device or on different devices. Here, engine 25 and plug-ins 26 run on computer 19 and relay 22 runs on server 20. Plug-ins 26 are installable computer programs that are responsible for collecting the state of hardware, operating systems and/or applications, in a device that is being managed/monitored by agent 24. Examples of operating systems that may be managed/monitored include, but are not limited to, the Microsoft® Windows® family (Intel 8086-like hardware platform), including NT4® (Workstation, Server, Terminal Server), Windows2000® (Professional, Server, Advanced Server) Windows9x® (95(all versions), 98 (all versions) and ME (Millennium), and Linux versions kernel 2.2, 2.4 (RedHat 6.2 and above, Conectiva 6.0 and above).

The plug-ins constitute shared libraries containing system calls for collecting data from a device. Engine 25 is a computer program that is responsible for controlling plug-ins 26, grouping the collected data and sending the data to relay 27 using, e.g., transmission control protocol/internet protocol (TCP/IP). Relay 27 is a computer program that is responsible for sending the collected data to server 21 over the Internet (or, more generally, external network) via, e.g., SMTP, HTTP or SSL. Relay 27 need not be installed in all computers on internal network 11. A client can choose to install relay 27 on a single computer on internal network 11 with Internet access and direct all agents running on internal network 11 to send data to that one relay, which will then send the data to server 21.

Agent 24 may be installed on the device to be monitored, as is the case here, or it may be stored on another devices (e.g., a server) on the same internal network as the device to monitored (which is the case for network peripherals management). During the installation process, relay 27 is configured to permit functions such as sending and receiving messages using e-mail or HTTP or SSL. Engine 25 is then executed. After engine 25 is executed for the first time, it calls all the installed plug-ins and reads configuration information contained therein.

Engine 25 creates a schedule to call the plug-ins at periodic time intervals. Once engine 25 is up and running, engine 25 will, at the time intervals, call the plug-ins. For example, a plug-in can be scheduled to execute every minute, every 5 minutes, and so on. After each plug-in executes, the plug-in returns data that it collected to engine 25.

In this embodiment, the following plugs-ins are available, although other plug-ins may be used instead of, or in addition, to the following. “Sysinfo” collects information regarding the configuration of the entire system from the point of view of the system's operating system. “Vmstat” collects information regarding the CPU usage and memory usage of the computer system where the plug-in is installed. “Iostat” collects information regarding the disk I/O usage of the computer system where the plug-in is installed. “Netstat” collects information regarding the network statistics of the computer system where the plug-in is installed. “Fsinfo” collects information regarding the file system of the computer system where the plug-in is installed. “Psinfo” collects information regarding the processes that are running on the computer system where the plug-in is installed. “Swpinfo” collects information regarding the swap area of the computer system where the plug-in is installed. “Lvminfo” collects information regarding the logical volume manager of the computer system where the plug-in is installed. “SQL Server”, where “SQL” stands for “Structured Query Language”, collects information regarding the state of a Microsoft® SQL SERVER 2000® database server on internal network 11. The “SQL SERVER plug-in” collects data that enables server 21 to generate a detailed report regarding the configuration, performance, etc. of the SQL SERVER 2000® database server. “Network” collects information from network devices that are connected to internal network 11, i.e., devices that are not physically part of the device on which agent resides, but are in the same internal network. “Oracle” plug-in collects information regarding the state of an Oracle® database server on internal network 11. The Oracle plug-in collects data that enables server 21 to generate a report regarding the configuration, performance, etc. of the Oracle® database server.

Engine 25 receives the collected data from plug-ins 26 and stores the collected data in a file in a binary and, in this case, proprietary format. Engine 25 compresses the file using a compression technique, such as the BZ2 compression method. Engine 25 sends the compressed data to the relay, which is responsible for encrypting the data.

Relay 27 receives data collected by one or more agents on internal network 11, encrypts the data, and sends the data through the Internet to server 21, where the data is analyzed. Relay 27 can run in a device other than the monitored (shown) device and can receive connections from more than one agent simultaneously. The relay's connection to the internet may be dial-up or permanent and may support SMPT, HTTP and/or SSL. In addition, the relay supports proxies and SOCKS (Windows® sockets), making it easier for outbound connections to go through firewalls.

In this embodiment, relay 27 uses two methods of encryption. The encryption method that relay 27 selects corresponds to the transfer protocol that relay 27 uses to send the data to server 21. If SSL is used to transfer the data, relay 27 uses the encryption method that is available from the OpenSSL library. In this embodiment, SSL version 3/Transport Layer Security (TLS) version 1 with Rivest, Shamir, and Adelman (RSA), Triple Data Encryption Standard (3DES) is used with a key of 128. RSA is a public-key encryption process developed by RSA Data Security, Inc. The RSA process is based on that fact that there is no efficient way to factor very large numbers. Deducing an RSA key, therefore, requires large amounts of computer processing power and time. The RSA process has become the de facto standard for industrial-strength encryption. DES is a popular symmetric-key encryption method that uses a 56-bit key.

If SMTP or HTTP are used to transfer the data, relay 27 encrypts the data using the sapphire, symmetrical, encryption process, in which the key used is a session key. This means that the key will only be used once. The key used is 128 bits. The server needs this key for decryption. Therefore, relay 27 uses the RSA, asymmetrical, encryption process to encrypt the key using a 1024 bits key.

Server 21 includes a computer program 29 to receive the encrypted and compressed data from agent 24, decrypt and decompress the data, and store the data in a database 22. Database 22 may be part of, or external to, server 21. Computer program 29 also retrieves the data from database 22 and presents the data to a client 30. Computer program 29 may include a Web server module, which formats the data and makes the data accessible as a Web page or even a WAP (Wireless Application Protocol) page. The formatting may also include generating a report in Adobe PDF format or using Java applets for displaying real-time graphics of data collected by the agents. An additional form of communicating information being collected by the agents that can be employed by server 21 is notifications. Notification are “real time” alerts sent every time a certain event happens (such as a threshold being exceeded) to portable communication devices such as cellular phones, pagers, etc. In this context, real-time is defined roughly by the data sampling rate of the agent and any delays associated with data transmission.

The notification process may operate as follows. The user can specify occurrences that prompt a notification and the necessary configuration. For example, the user can be notified in response to changes in CPU usage, memory usage, disk I/O, network I/O, file system/logical drive utilization, and the status of a process. For CPU usage, memory usage, disk I/O, network I/O, file system/logical drive utilization, the user configures a high point and a low point, e.g., CPU Utilization has the high point set to 80% and low point to 50%. The following scenarios may occur: (1) The user has the high point flag set to false and the value is below the high point. (2) The value reaches the high point and the flag is set to false. In this case the user receives the form of notification chosen and the high point flag is set to true. (3) The value is above the high point and the high point flag is true. Nothing is done here, since the user has already been notified. (4) The value is below the high point, above the low point and the high point flag is true. Nothing is done here. (5) The value is below the low point and the high point flag is true. The user is notified that it reached the low point and the high point flag is false

Notifications in response to the status of a process status function analogously. The user provides the name of the processes to be monitored. A user is notified once when the process stops running and receives a notification when the process starts running again. Generally speaking, only the resources the user has chosen are verified.

Computer program 29 also analyzes the data collected from a device (e.g., device 19) in order to produce a natural language and conclusive report. In this context, the term “natural language” means a human-readable format that can be presented and understood by, e.g., a network administrator or the like. Computer program 29 generates the reports according to a rule-based system. For each of the reports there are sets of rules that determine what goes in the report.

In this embodiment, computer program 29 includes the following software modules (called “wizards”) for generating different types of reports. Performance Wizard Service delivered through the Internet analyzes the foregoing performance of computational servers and presents results by means of conclusive, natural language reports. Consolidated Performance Wizard Service delivered through the Internet analyzes the foregoing performance of a group of computational servers, as a whole, and presents the results by means of conclusive, natural language reports. Capacity Wizard Service delivered through the Internet infers the future performance behavior of computational servers, studies possible upgrades, and presents results by means of conclusive, natural language reports. Consolidated Capacity Wizard Service delivered through the Internet infers the future performance of a group of computational servers, as a whole, and possible upgrades, and presents the results by means of conclusive, natural language reports. Real Time Monitoring (RTM) Service delivered through the Internet shows, via an Internet browser or WAP (Wireless Application Protocol)-enabled device (such as a mobile phones or notepad), the updated status of the computational resources (such as memory usage, CPU usage, disk usage and network interface usage) of a computer. The service can also send alerts by WAP, SMS (Short Message System), e-mail or similar electronic communication channels whenever the consumption of each computational resource exceed pre-defined thresholds. The RTM Wizard service generates real-time graphical displays of data from an agent monitoring a device on internal network 11. Asset Wizard Service delivered through the Internet collects, keeps and analyzes information about computer hardware and software components such as hardware internal configuration, operating system version, installed software and upgrade history. Oracle Wizard Service delivered through the Internet analyzes the foregoing performance behavior of an Oracle© database and presents the results by means of conclusive, natural language reports. SQL Server Wizard Service delivered through the Internet analyzes the foregoing performance behavior of a Microsoft SQL Server© database and presents the results by means of conclusive, natural language reports.

The rules used by computer program 29 are static and configurable in terms of thresholds and tolerances. This means that the addition of new rules requires adding or changing existing code in computer program 29, while changing the criteria of existing rules does not require such a change. Thresholds define a level, for a given resource consumption variable, above which, resource usage is considered critical. For instance, with computer processing units (CPUs), a threshold value is 75% utilization. Tolerances define for what percentage of an analyzed period a threshold was exceeded. Exceeding a threshold may not indicate a problem, unless the threshold is exceeded for a certain amount of time.

There are four combinations of situations involving thresholds and tolerances: (1) a threshold was never exceeded, (2) a threshold was exceeded for a period of time below tolerance, (3) a threshold was exceeded for a period of time above tolerance, and (4) a threshold was exceeded all the time. Different text may be provided (e.g., displayed) in a report for each of these four situations, for every resource variable being analyzed, and for every language supported.

Prior to operation, agent(s) (including engine, relay and plug-ins) are installed on computers of internal network 11. Installation may be performed by downloading the agent software from a Web site. An agent may be downloaded and installed for each type of platform on the internal network, e.g., Linux, Windows2000, etc. The agent is installed on each device to be monitored and in each device that is to act as a relay for internal network 11. A user, such as a network administrator, identifies himself (e.g., by e-mail address) and selects desired installation options. The agent automatically enables operation under the user's account through a Web site, such as “my.automatos.com”, that is accessible via the Internet. The user then activates the monitoring services on the various devices. Installation options are described in more detail below.

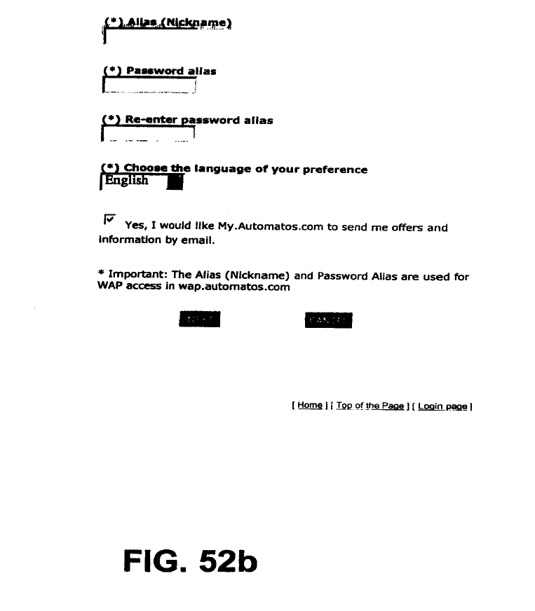

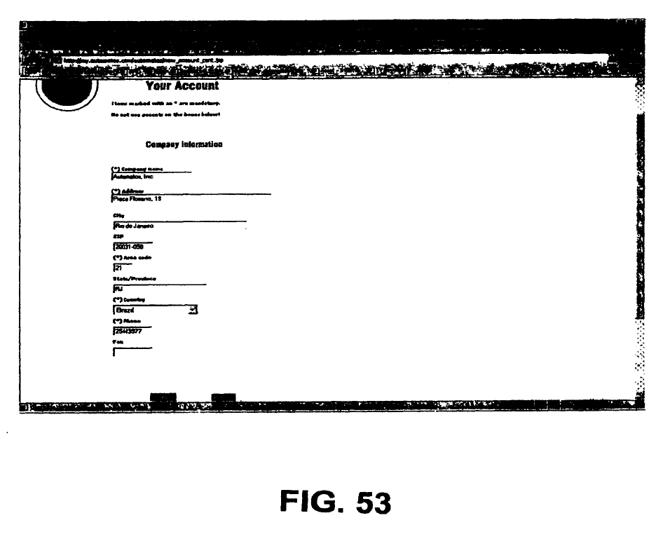

FIGS. 52a and 52b show Web pages for creating an account via a Web site, from which the agent can be downloaded. The Web pages request identification information for the user, such as the user's name, e-mail address, a password, and language preference, among other things. FIG. 53 shows a similar Web page for entering information on the company of the user that enrolled via the Web pages of FIGS. 52a and 52b. Once enrolled, the user downloads the agent from the Web site and begins the installation process.

During installation and operation, agent 24 generates and displays a graphical user interface (GUI) that has three tabs for checking the status of the agent and altering the agent's operation. The tabs are: “Status”, “Settings” and “Start/Stop”. Each tab may have different panels. Each panel presents a set of closely related parameters displayed in separate fields. Some of these parameters can be edited. Each tab is described below, along with the meaning and functionality of the fields contained therein.

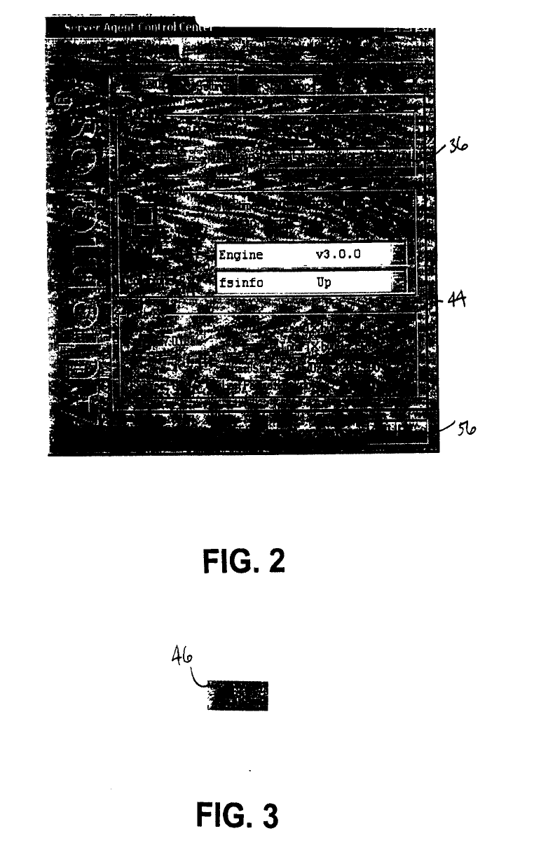

FIG. 2 shows an example of status tab 31. Status tab 31 is displayed on a device running agent 24. The fields in status tab 31 are fixed, meaning that they cannot be edited.

In FIG. 2, machine panel 32 presents information describing the device on which the agent is installed, e.g., device 19. This information includes the operating system 34 of the device, the name 35 of the device and the MachineID 36 of the device. “MachineID” is the device's machine identifier. The Machine ID is a number that is generated during installation and that uniquely identifies device 19 to computer program 29 running in server 21 (shown in FIG. 1).

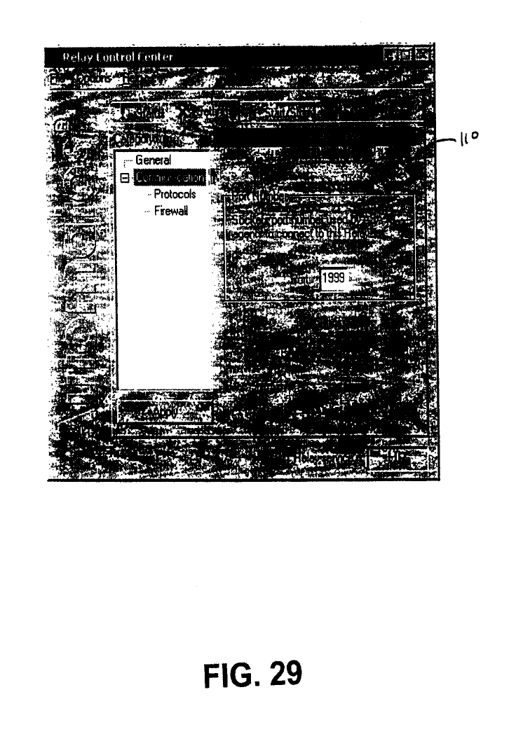

Agent panel 37 presents a start time 39, which is the date and time of the agent's activation, and a PID number 40, which is the agent's process ID (identifier) number. A process ID is a number that identifies a process in an operating system on the monitored device. Using the process ID or “PID”, it is possible to send signals to a process running in an operating system, such as an instruction for the process to terminate. The modules field 41 shows each active collection module and its version number. Each module is responsible for coordinating the collection of data related to a specific service (e.g., Capacity Wizard, Performance Wizard, etc.). Whenever plug-ins are installed for new services, new modules are inserted and collectors may be added. Collector field 42 shows the name of each collector within a device being managed and indicates if such collectors are active (“UP”). Each collector is responsible for collecting data from a certain device resource, such as hard disk, memory, etc. FIG. 28 shows status tab 31 with other options 43 in the pull-down menu of collector field 42.

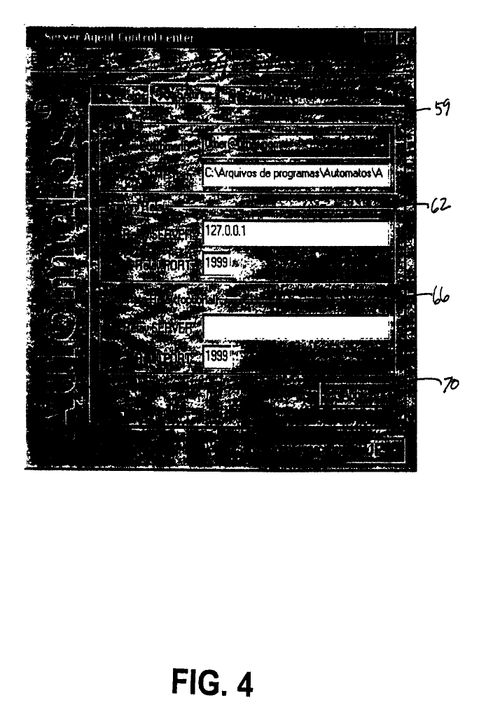

Data TX Panel 44 shows the Internet Protocol (IP) address 45 of the device in which the agent is installed and indicates if the device is currently sending samples to server 21. In the example of FIG. 2, the device's IP address is 127.0.0.1 and it is sending samples. If the device were not sending samples, icon 46 (FIG. 3) would be displayed in lieu of icon 47. LastTXBytes field 49 shows the amount of bytes sent to relay 27 in a last collected data sample. TotalTXBytes 50 field shows the total amount of bytes sent to relay 27 to present. Sent field 51 shows the amount of collected data sent to relay 27. Last Sent field 52 shows the date and time that the last collected data sample was sent to server 21. Failures field 54 shows the number of failed sample transmission attempts. Last Failures field 55 shows the date and time of the last failed sample transmission attempt. When no failures occur an “unknown” status is indicated (as shown).

Also shown in FIG. 2 is an agent service indicator 2. “UP” (shown) indicates that the agent is active. “DOWN” (not shown) indicates that the agent is inactive.

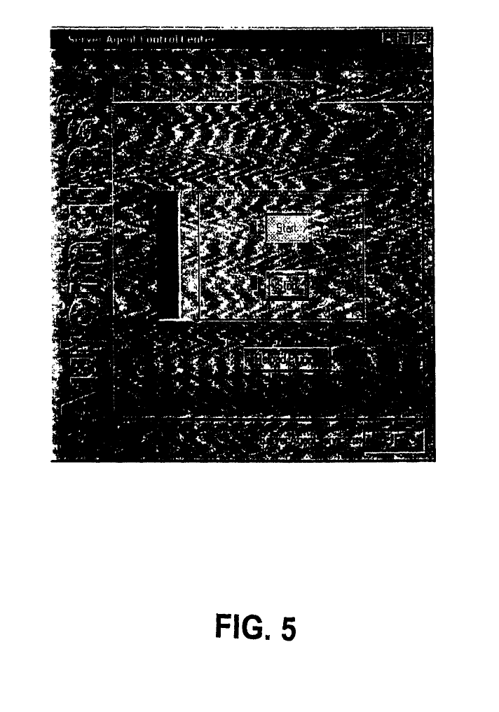

FIG. 4 shows an example of settings tab 57. Settings tab 57 is displayed on a device running agent 24. Some of the fields in settings tab 57 are fixed, others may be edited.

In FIG. 4, General panel 59 displays a customer ID field 60 and a TMP (temporary) path field 61. CustomerID field 60 shows the e-mail address used during enrollment and input when the agent is installed. TMP path field 61 shows where samples are stored until they are sent to relay 27. Primary Relay panel 62 contains Relay Server field 69, which shows the IP address of the primary relay device on internal network 11, and Relay Port field 65 which shows the primary relay device's IP port number.

Alternate Relay panel 66 includes a Relay Server field 67 and a Relay Port field 69. Relay Server field 67 indicates an alternate relay server's IP address. The alternate relay is automatically used when the primary relays is down. Relay Port field 69 provides the alternate relay server's IP port number. Clicking on Apply button 70 executes any alterations made in the fields shown in FIG. 4.

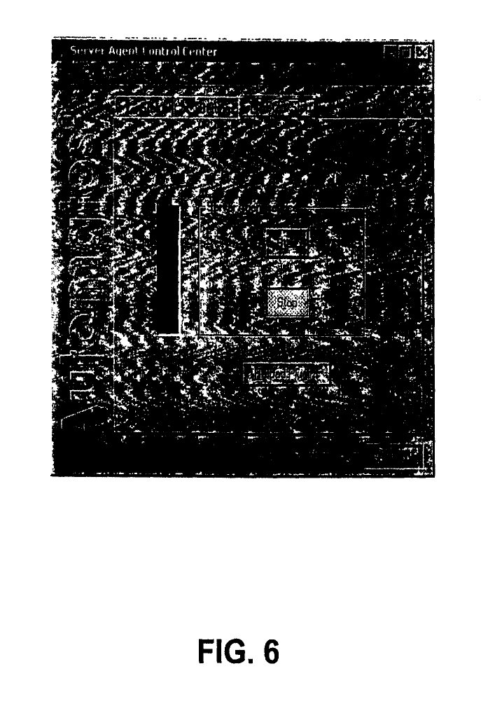

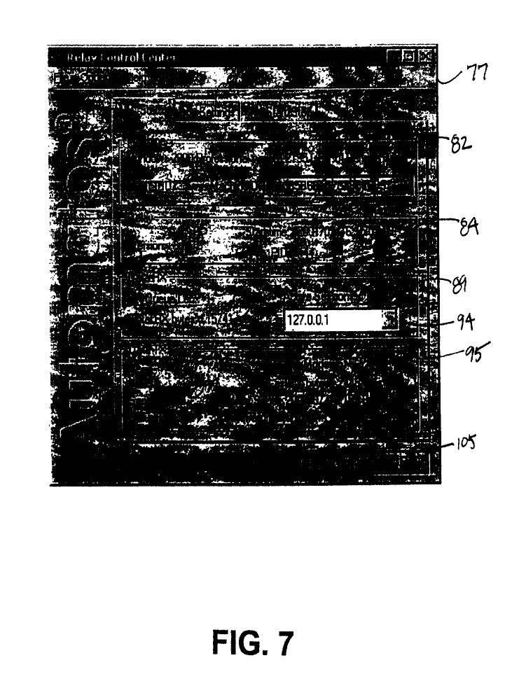

The Start/stop tab 71 is displayed on a device running agent 24. In this tab, it is possible to activate and/or deactivate agent data sampling. FIG. 5 shows start/stop tab 71 when agent 24 is active (“UP”). FIG. 6 shows start/stop tab 71 when agent 24 is inactive (“DOWN”).

In Agent Service panel 72, Start button 74 activates agent sampling (i.e., data collecting) (shown active) and Stop button 75 deactivates agent sampling. Reload Plug-ins button 76 reloads plug-ins installed in the agent.

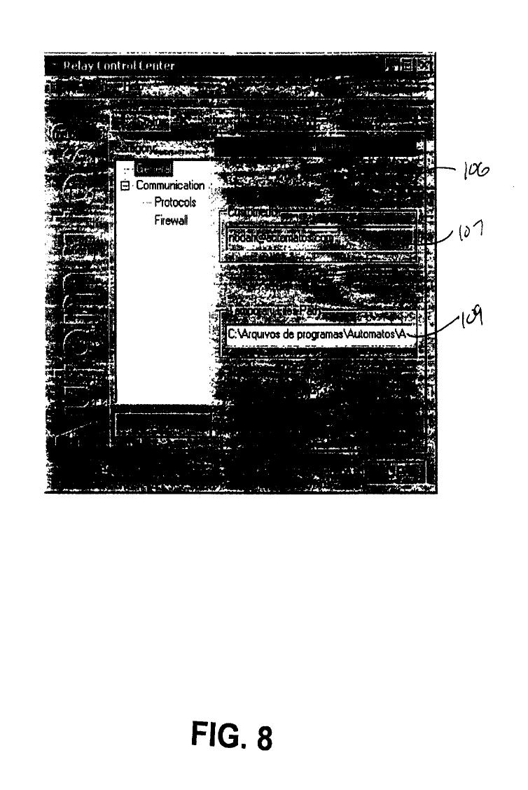

Referring now to FIG. 7, a GUI 77 for the relay is similar to the GUI (FIG. 2) for the agent. GUI 77 is displayed on relay server 20 (FIG. 1) during installation and/or operation. As shown in FIG. 7, relay GUI 77 also has Status tab 79, Settings tab 80, and Start/Stop tab 81 with similar panels and functionalities as those described above.

FIG. 7 shows the relay GUI status tab 79. As was the case with the agent GUI status tab, most of the fields in relay GUI status tab 79 cannot be edited.

Machine panel 82 presents information describing relay server 20, its operating system, name and MachineID. The example presented in FIG. 7 shows a computer (relay server) named “WRIEIRO2” executing Windows 2000 Professional with Service Pack 1 installed. The relay sever can be installed in a different operating system than the agents are installed.

Relay panel 84 includes Version field 85, which provides the relay's version number, Start Time field 86 which provides the date and time of relay activation, and PID field 87 which provides the process ID number.

Data RX (Receive) panel 89 includes the TX (Transmit) Queue Len field 90 which indicates a backlog of samples to send to server 21 (FIG. 1), TotalRXBytes field 91 which shows the total amount of bytes received by the relay from all agents until the present, and Active Sessions field 92 which shows the number of active agents' sessions that are sending samples to the relay. The IP addresses of the agents that are generating the samples are listed in drop-down field 94.

Data TX (Transmit) panel 95 includes the following fields. Data TX time field 96 shows the amount of time spent transmitting a last sample from relay 27 to server 21. Sent field 97 shows the amount of collected samples sent from relay 27 to server 21. Failures field 99 shows the number of failed data transmission attempts from relay 27 to server 21. Mode field 100 shows the mode of transmission from relay 27 to server 21: in this embodiment, either SMTP for e-mail data transmission or SSL for SSL data transmission. LastTXBytes field 101 shows the amount of bytes sent by relay 27 to server 21 in an immediately preceding transmission. Last Sent field 102 shows the date and time that the last collected sample was sent from relay 27 to server 21. Last Failure field 104 shows the date and time of the last failed data transmission attempt. When no failures occur “unknown” is displayed.

Status tab 79 also includes a relay service indicator 105. Relay service indicator 105 indicates “UP” when relay 27 is active and “DOWN” when relay 27 is inactive. When relay 27 is switched from “UP to “DOWN”, the TX and RX statistics are reset, e.g., TotalRXBytes, DataTXTime, etc.

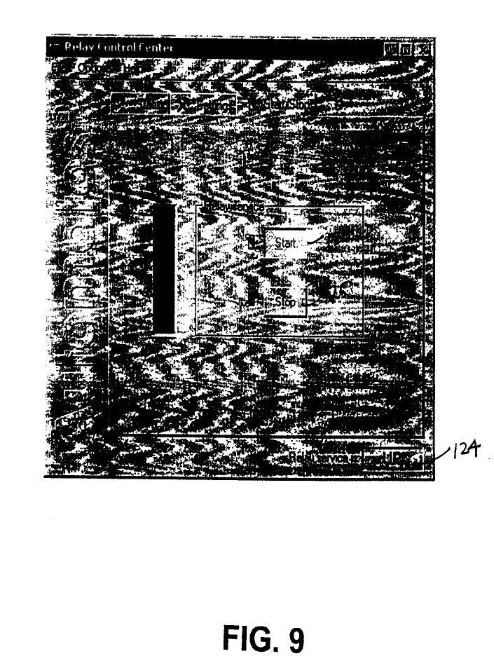

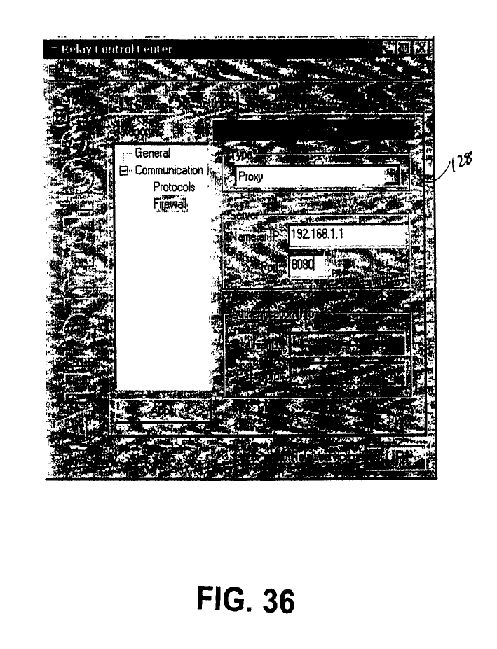

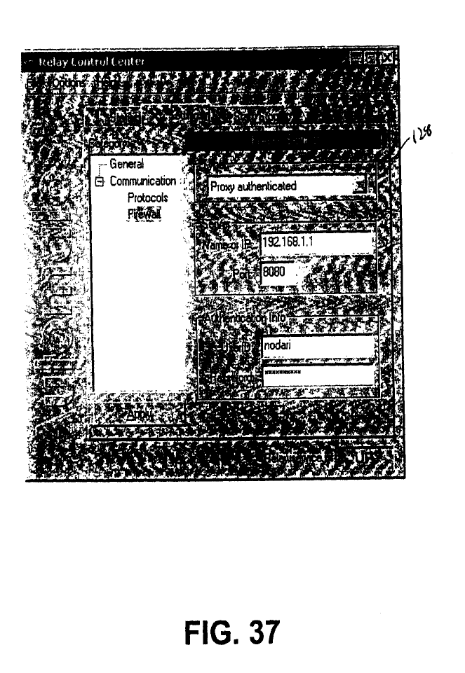

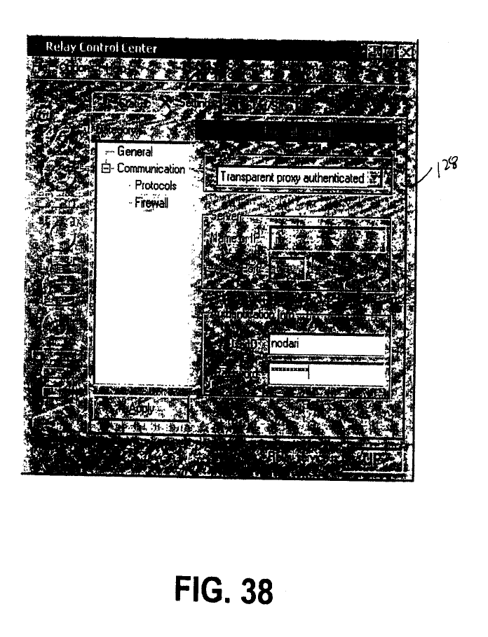

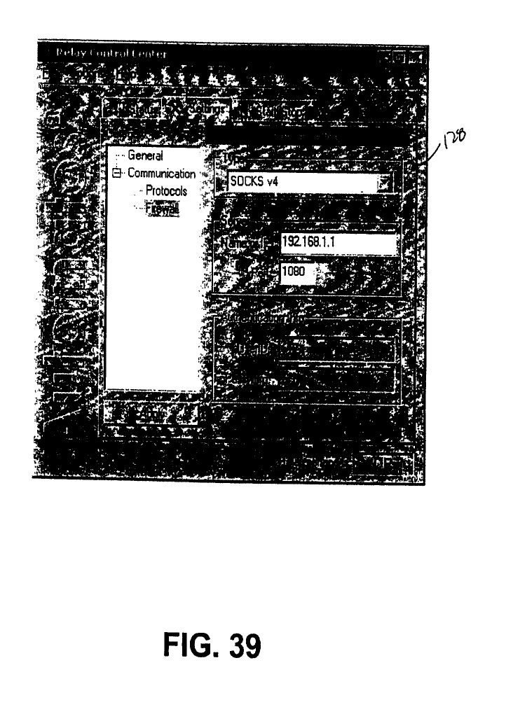

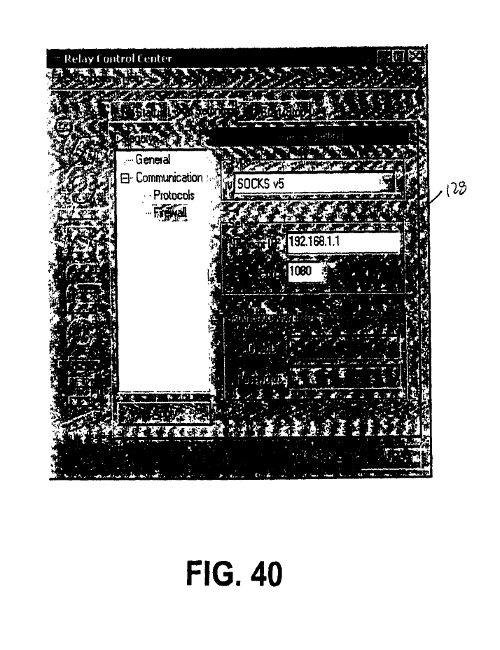

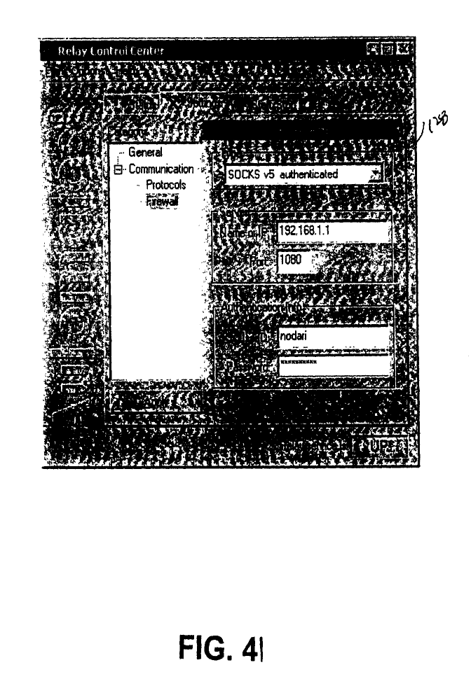

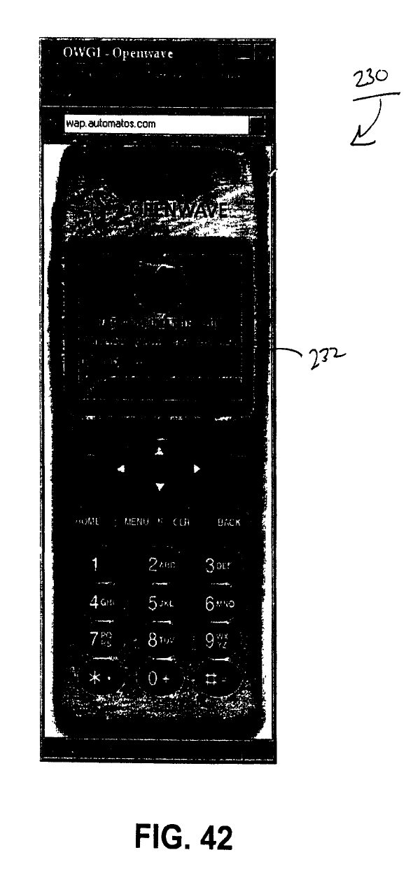

FIGS. 8 and 29 to 41 depict settings tab 80. Settings tab 80 is displayed on a device running relay 27. Some of the fields in settings tab 80 are fixed, others may be edited.

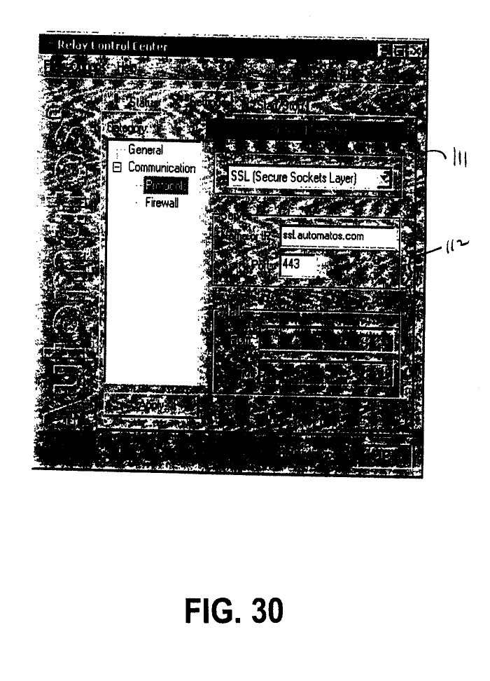

General Panel 106 (FIG. 8) includes the following fields. CustomerID field 107 displays the e-mail address input while installing the relay. This e-mail address identifies the user in my.automatos.com and cannot be edited. TMP path field 109 indicates where samples are stored until they are sent to server 21. Communications port field 110 (FIG. 29) displays the IP communication port used to transmit samples from agent 24 to relay 27. In this example, the default value is 1999.

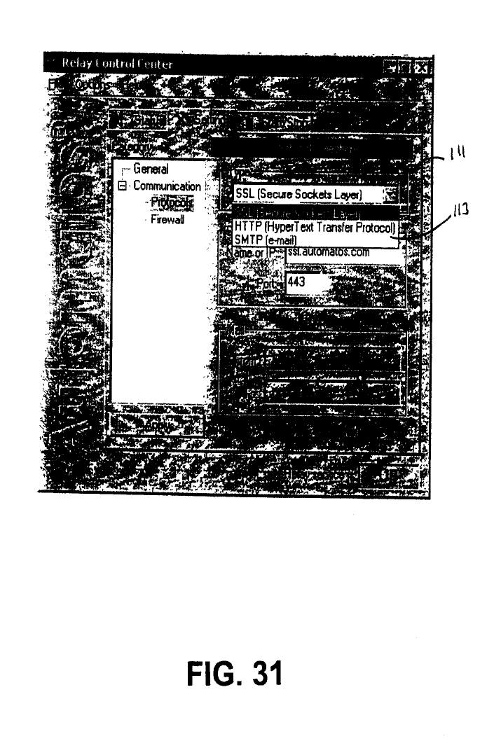

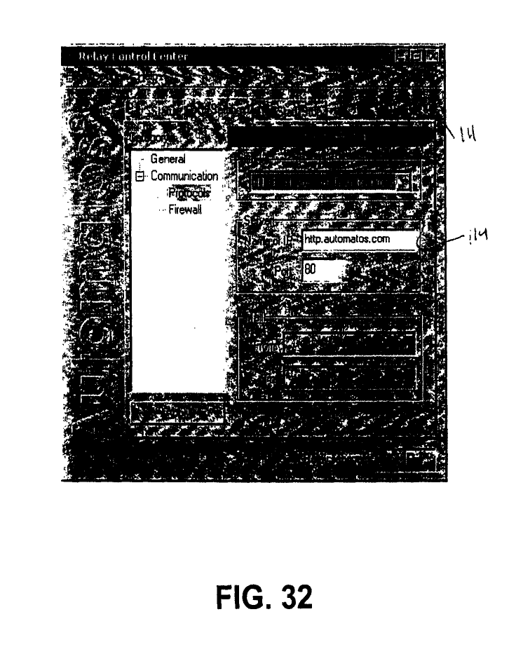

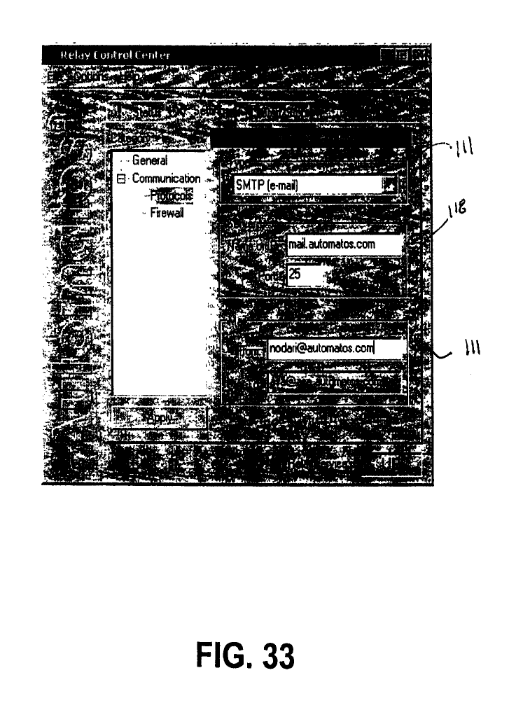

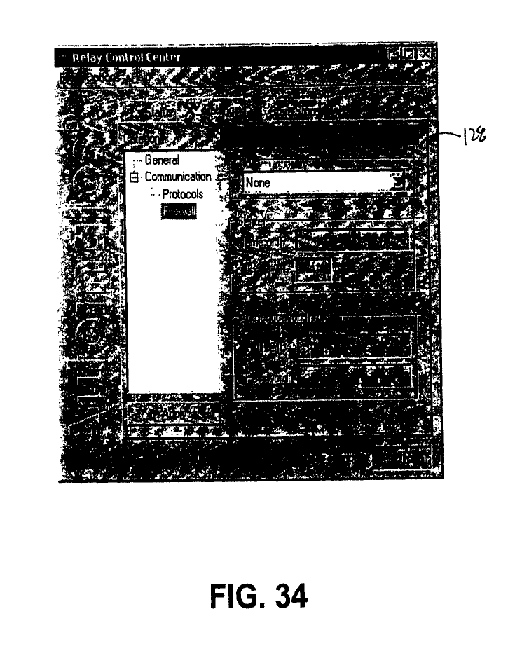

Protocol selection panel 111 (FIGS. 30 to 33) allow a user to select protocols 113 (FIG. 31), including SSL, HTTP and SMTP, that may be used to transmit data over the Internet. FIG. 30 shows the case where SSL is selected. In this case, the server name and port 112 are input. FIG. 32 shows the case where HTTP is selected. In this case as well, the server name and port 114 are input. FIG. 33 shows the case where SMTP is selected. In this case the server name and port 118 are input, along with e-mail addresses 111, including the sender's e-mail address (“FROM”) and the recipient's e-mail address (“TO”). In this embodiment, the SMTP server default address is mail.automatos.com (not shown) and the SSL server default address is ssl.automatos.com (not shown).

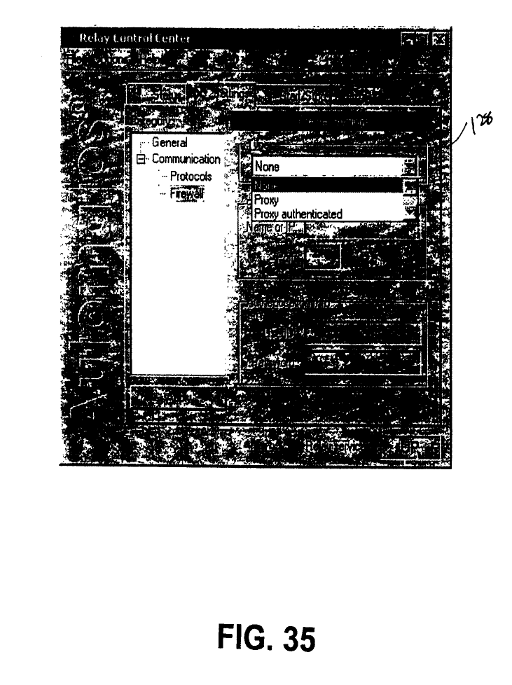

FIGS. 34 to 41 shows screens for allowing a user to select firewall settings 128. In this embodiment, there are several proxy and Windows® sockets (SOCKS) configurations. Basically, the user inputs the name or IP address of the proxy or SOCKS server and the port of the proxy or SOCKS server. In the case of an authenticated proxy or SOCKS server, a login ID and password may be required. Different screen configurations for inputting this information are shown in FIGS. 34 to 41.

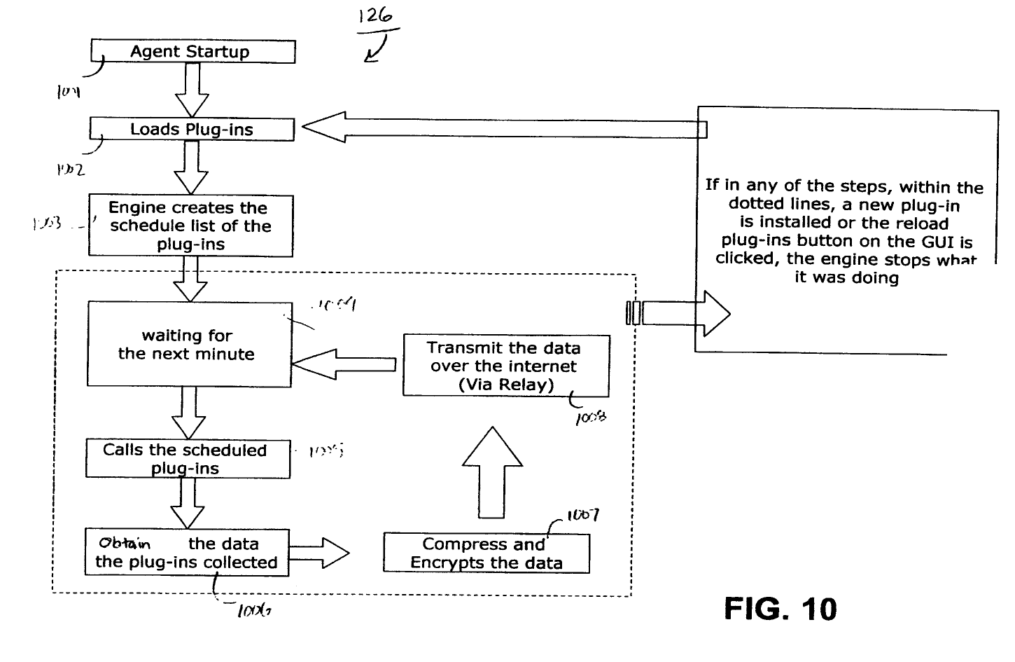

The Start/stop tab 81 (FIG. 9) is displayed on a relay device. In this tab, it is possible to activate and/or deactivate data sampling transmission. Start/stop tab 81 indicates “START” 122, when relay service is “UP” 124, and “STOP” 125 when relay service is “DOWN” (not shown).

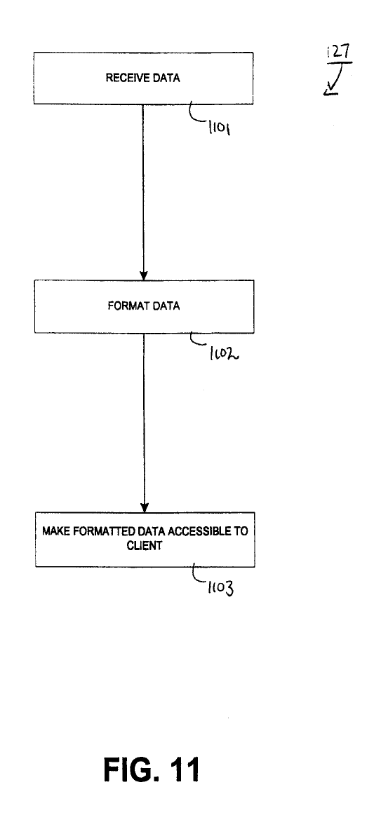

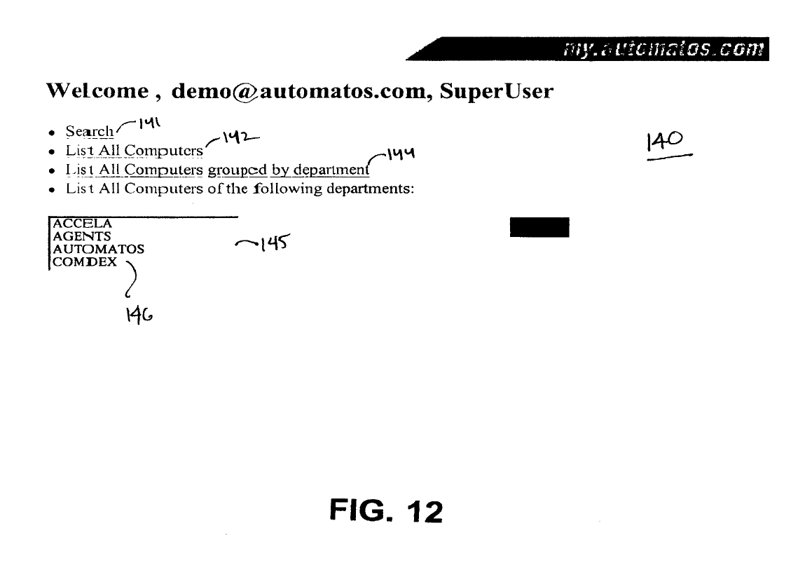

FIG. 10 shows a process 126 performed by agent 24 (including relay 27) for obtaining data from a device and providing that data to a remote server (or other type of processing device). FIG. 11 shows a process 127 performed by remote server 21 for processing received data and making that data accessible to remote client 30, e.g., over the Internet.

Referring also to FIG. 1, in process 126, agent 24 is activated and receives (1001) a plug-in containing system calls for obtaining data from device 19. It is noted that agent 24 may use a previously-installed plug-in to obtain data from device 19. A new plug-in is used if agent 24 needs to retrieve added or different data not obtainable by plug-ins already available to agent 24. Agent 24 loads (1002) the new plug-in, along with the pre-existing plug-ins.

As noted, engine 25 creates (1003) a schedule to call the plug-ins at periodic time intervals. For example, a plug-in can be scheduled to execute every minute (as in this example), every 5 minutes, and so on. After each plug-in executes, the plug-in returns data that it collected to engine 25.

Accordingly, process 126 waits (1004) for the scheduled time interval (one minute here) and calls (1005) the scheduled plug-in at the appropriate time. The plug-in collects the appropriate data from the monitored device. Here, engine 25 uses system calls from the new plug-in to obtain (1006) data from device 19. Engine 25 may also obtain any other available data using the system calls from the pre-existing plug-ins. The data may relate to, but is not limited to, one or more of the following: a processor on the device, a memory on the device, a hard drive on the device, an internal network on which the device is located, an operating system of the device, and/or software installed on the device.

Engine 25 compresses (1007) the obtained data and transmits the compressed data to relay 27. As noted above, relay 27 may reside on the same device as engine 27 or on a different device (shown).

Relay 27 encrypts (1007) the data that it receives from engine 25 and transmits (1008) the encrypted data to server 21 over the Internet. Blocks 1004 to 1008 may be repeated periodically, as shown, in order to obtain real-time data from device 19. Data is thus transmitted from agent 24 to server 21 periodically, thereby allowing a client to monitor changes in device 19 in real-time. This feature is described in more detail below.

In process 127 (FIG. 11), server 21 receives (1101) the compressed and encrypted data. The data is received periodically, as it is transmitted, e.g., every minute, five minutes, etc. Computer program 29 in server 21 decompresses and decrypts the data and stores the data in database 22. Alternatively, instead of storing the data in database 22, computer program 29 may process the data as it is received, which is the case when real time notification is utilized.

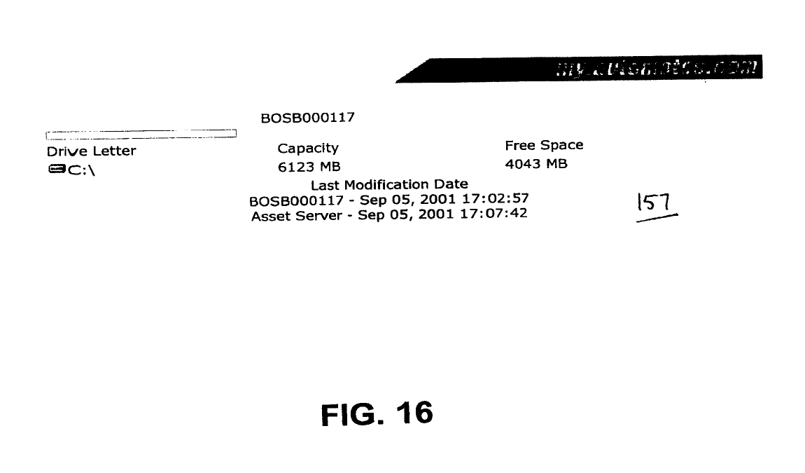

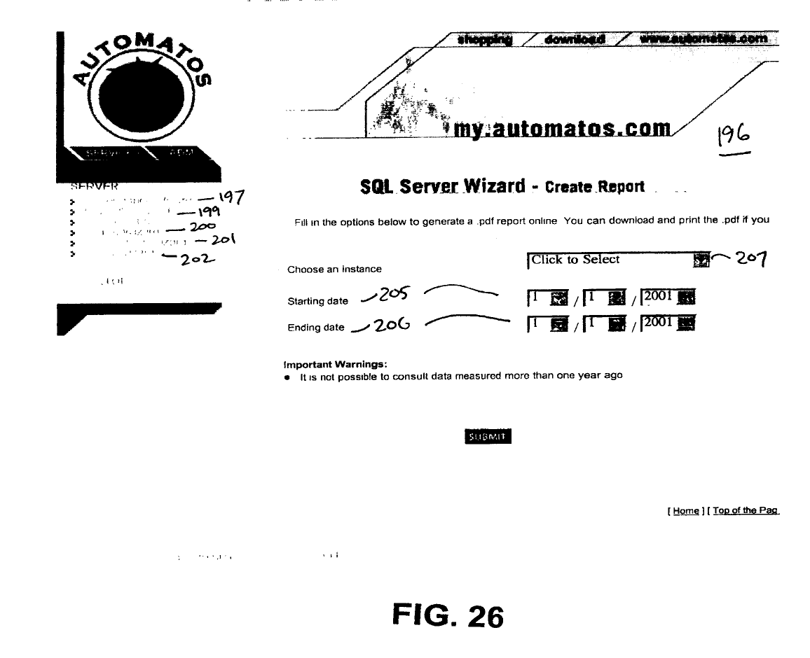

Computer program 29 formats (1102) the data for display. In this embodiment, the data is formatted as one or more Web pages (e.g., FIGS. 15 to 18), reports (see the attached appendices), notification messages (e.g. pager messages, e-mails, etc.) and/or or graphs/charts (e.g., FIG. 25) for showing real-time operation/behavior of device 19.

Computer program 29 makes the formatted data accessible to a remote client via the Internet. That is computer program 29 functions as a Web server to provide a Web site containing Web pages with the formatted data. A user at client 30 can navigate through the site/data via one or more hyperlinks. Computer program 29 may generate natural language reports that indicate an operational parameter of a device exceeds a preset limit. In this scenario, computer program determines if received data indicates that an operational parameter of the device exceeds a preset limit and generates a report to client 30 indicating that the preset limit has been exceeded. Preset limits for the operational parameters may be stored in, and retrieved from, database 22 by computer program 29.

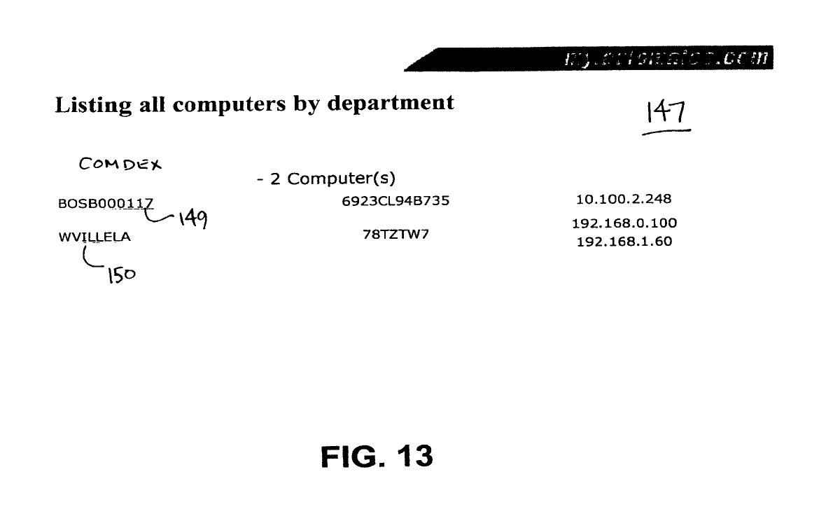

Client 30 (FIG. 1) can access the formatted data from server 21 through one or more Web pages. FIG. 12 shows an example of a Web page 140 that can be used to access the data. Web page 140 contains hyperlinks 141, 142 and 144 to data for devices, in this case computers, being monitored by agents. Window 145 provides a list 146, which contains groupings by “department” of one or more devices being monitored by agents.

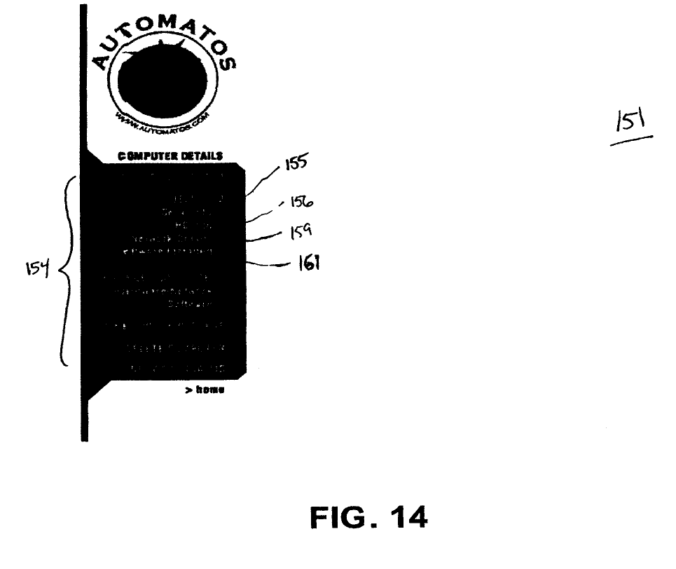

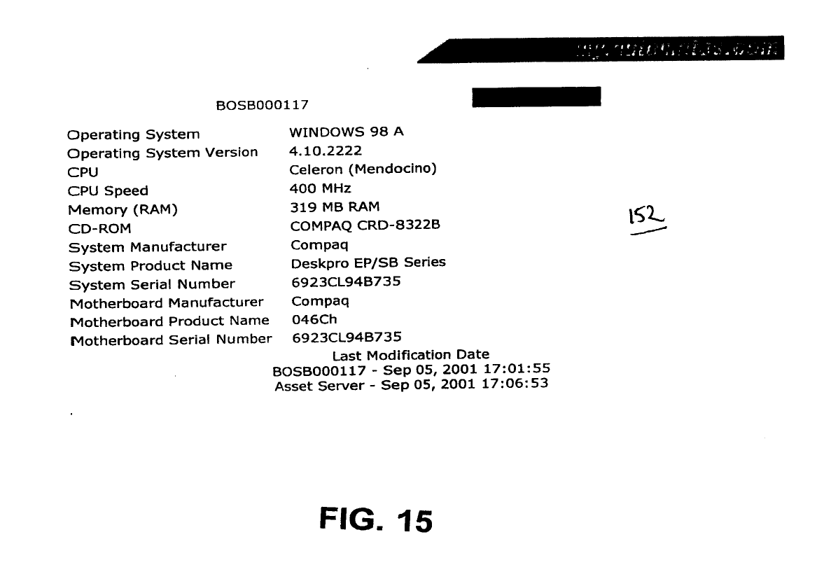

Clicking on hyperlink 142 provides links to data for all computers being monitored. Clicking on hyperlink 144 provides links to data for a selected group from list 146. If hyperlink 146 is selected, Web page 147 (FIG. 13) is displayed. Web page 147 contains link 149 to one computer (BOSB000117) and link 150 to another computer (WVILLELA). Clicking on hyperlink 149 displays Web page 151 (FIG. 14). Web page 151 provides hyperlinks 154, which allow a user to display information about the selected device.

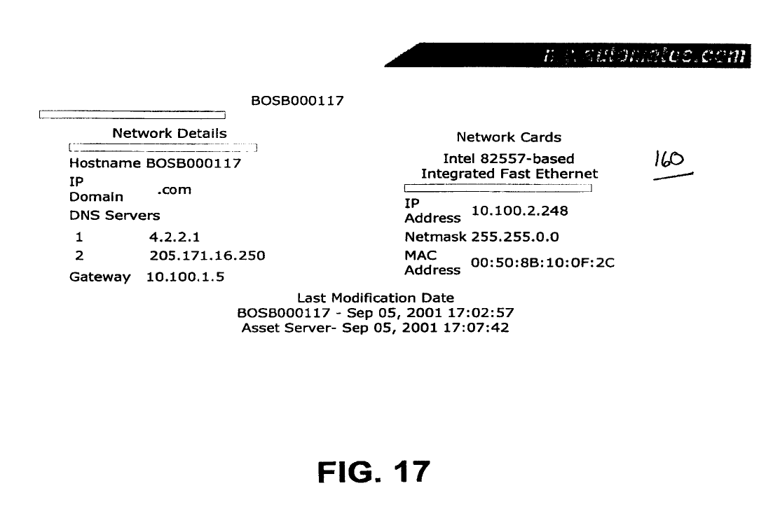

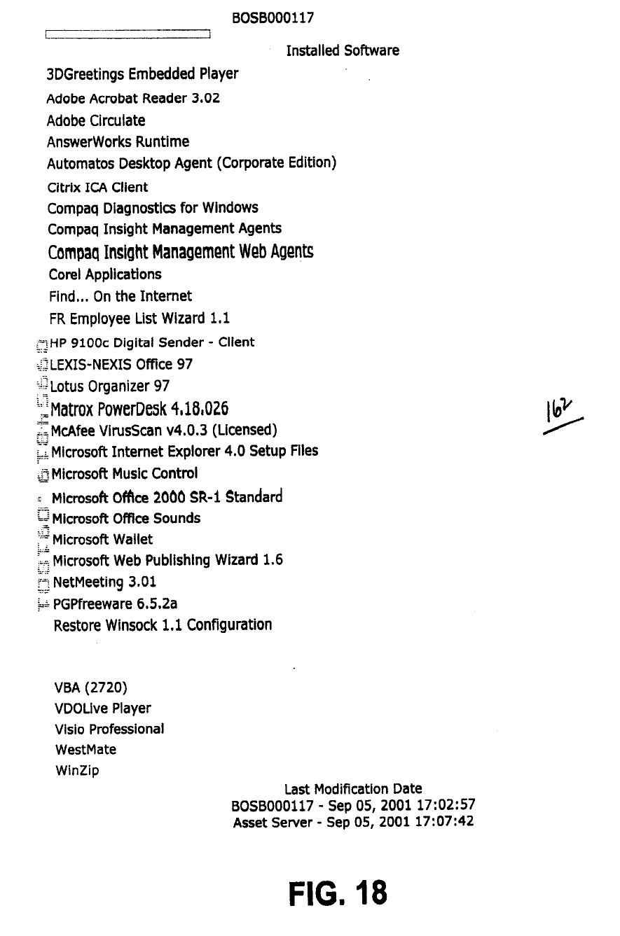

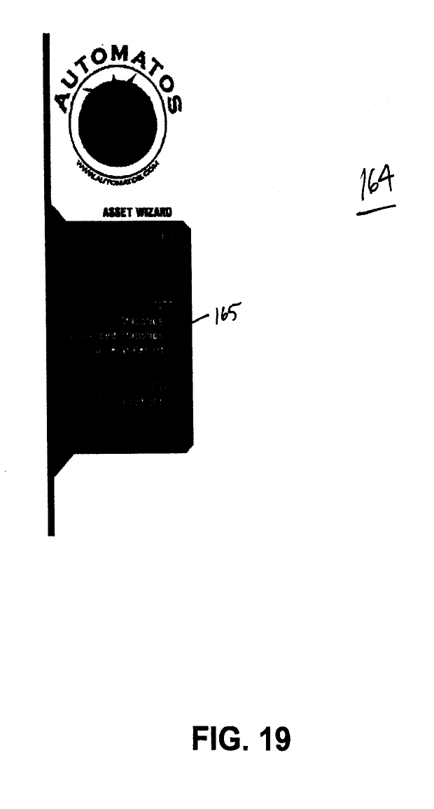

Clicking on hyperlink 155 displays the general information shown on Web page 152 (FIG. 15) about the selected computer. Web page 152 displays information about the configuration and operation of the selected computer. As shown, this information includes the operating system on the computer, the operating system version, the CPU on the computer, the CPU speed, the amount of memory, the type of CD-ROM (Compact Disc Read Only Memory) on the computer, along with other information. Clicking on hyperlink 156 (FIG. 14) displays the capacity of the device's hard drive, shown in Web page 157 (FIG. 16). Clicking on hyperlink 159 displays network information (e.g., the IP address) for device 19, shown in Web page 160 (FIG. 17). Clicking on hyperlink 161 displays a list of the software installed on device 19, shown in Web page 162 (FIG. 18). Other information also may be accessible.

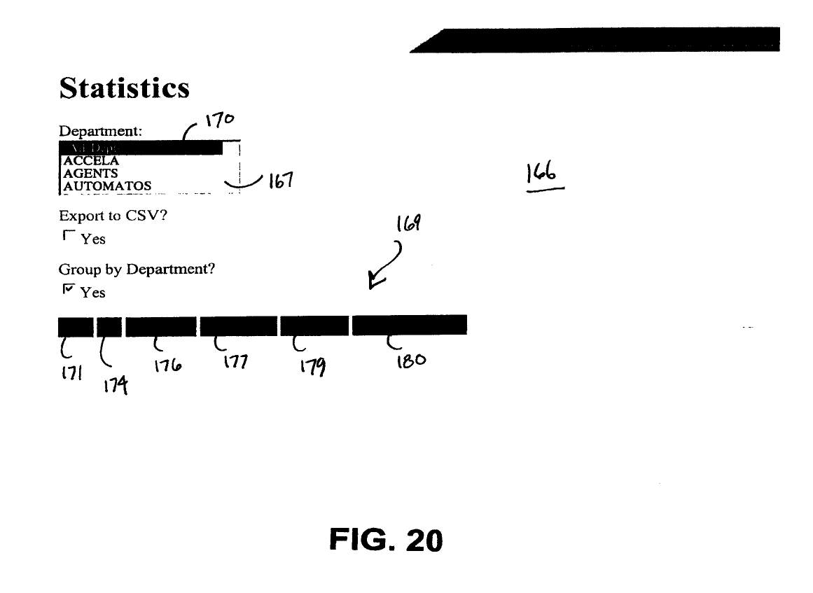

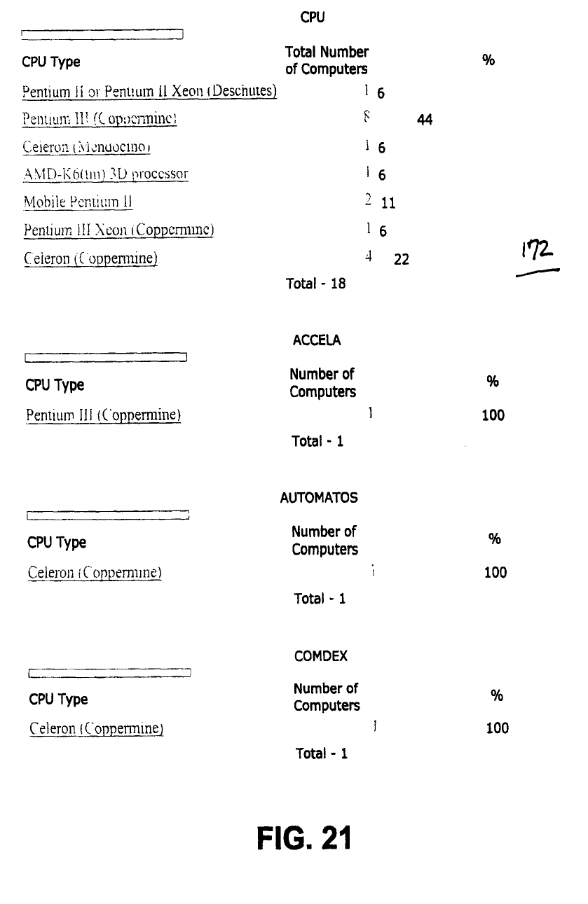

Web page 164 (FIG. 19) is also accessible through the Web site provided by server 21. Web page 164 provides options for viewing statistics relating to monitored devices. For example, clicking on hyperlink 165 displays Web page 166 (FIG. 20). Web page 166 provides a list 167 of groupings of devices (by department), along with buttons 169 which link to Web pages that provide statistics for a selected grouping from list 167.

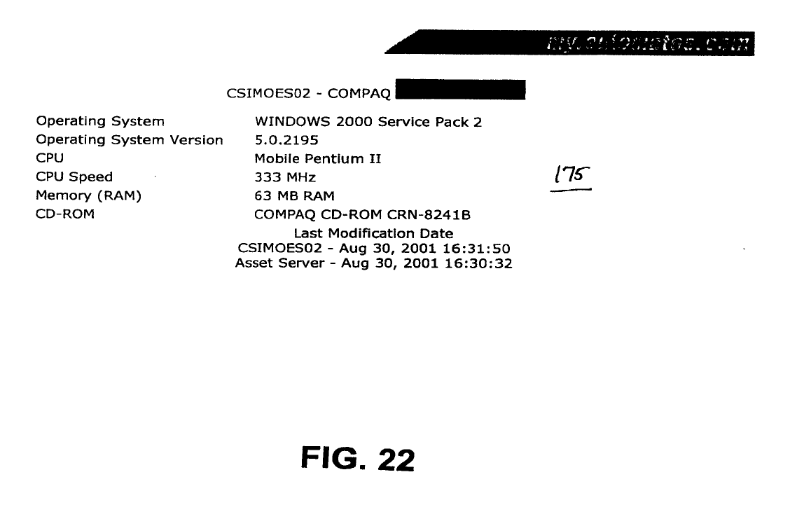

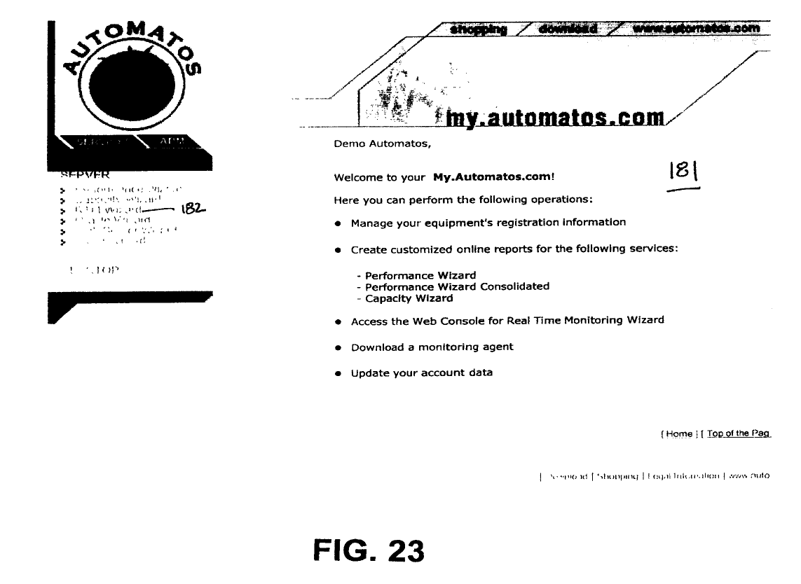

Selecting “All Dept” 170 and button 171 on Web page 166 displays Web page 172 (FIG. 21). Web page 172 identifies the CPU on all computers from list 167. To select only computers from a single group (i.e., department), select that group and button 171. Selecting button 174 (FIG. 20) generates a Web page 175 (FIG. 22) that displays operating system information for computers from a selected group. Selecting button 176 generates a Web page (not shown) that displays memory statistics for computers from a selected group. Selecting button 177 generates a Web page (not shown) that displays software statistics (e.g., software installed, versions, etc.) for computers from a selected group. Selecting button 179 generates a Web page (not shown) that displays product information (e.g., model, version, etc.) for computers from a selected group. Selecting button 180 generates a Web page (not shown) that displays manufacturer information for computers from a selected group.

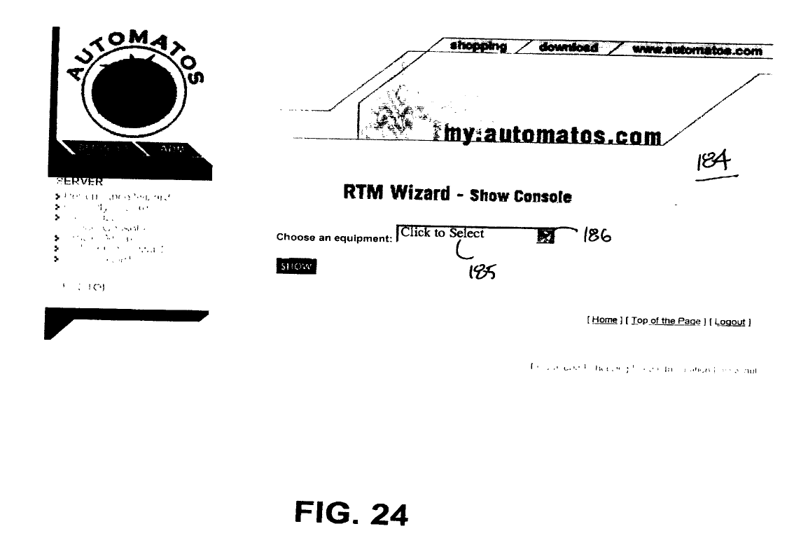

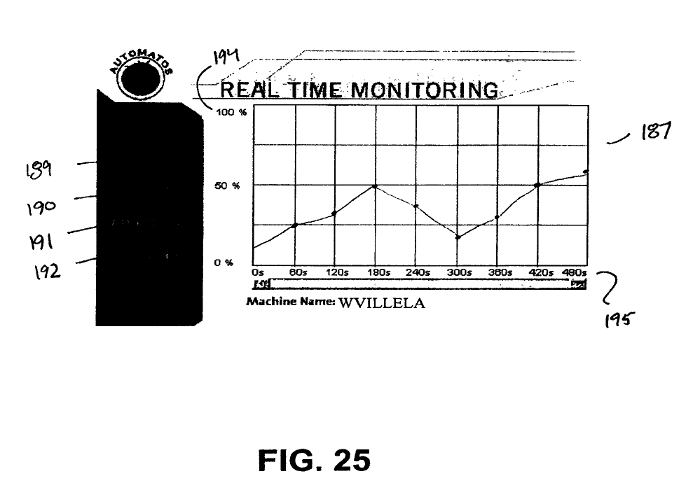

FIG. 23 shows another example of a Web page 181 displayed by server 21. Web page 181 allows a user to access services through server 21. Among these services are real-time monitor (RTM) wizard 182. RTM wizard 182 is part of computer program 29 and allows a client to view data from device 19 as that data changes in real-time. Selecting RTM wizard 182 displays Web page 184 (FIG. 24), in which a user can select a device 185 to be monitored from pull-down menu 186. Once the device has been selected, a window 187 (FIG. 25) is displayed for showing the status of a selected function over time. In this embodiment, a user can choose to monitor a device's memory usage 189, disk input/output (I/O) 190, CPU usage 191, and network I/O 192. The selected function is displayed in terms of percentage of use 194 versus time 195 and is updated automatically as new data arrives at server 21.

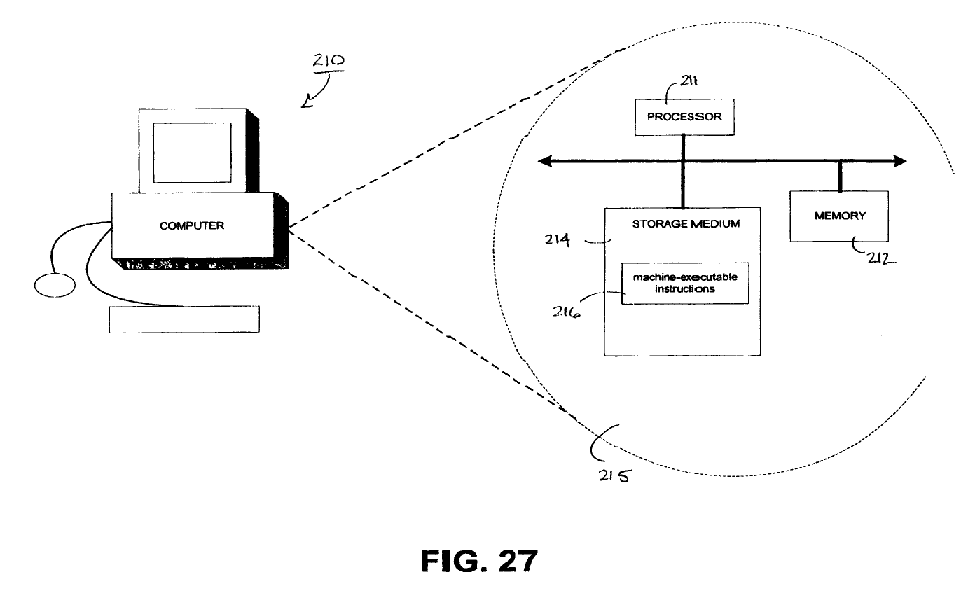

Web page 196 (FIG. 26) also provides options for obtaining natural-language reports based on the data collected by agent 24. Performance wizard 197, capacity wizard 199, Oracle wizard 200, SQL server wizard 201, and asset wizard 202 are software modules that are included within computer program 29. These modules analyze the data received from the agent(s), generate reports, and provide those reports to a user, in Adobe PDF format, at client 30, on demand (through the site) or automatically (by e-mail).

Generally speaking, the various reports generated by the “wizards” provide information relating to one or more devices on a network over a period of time, although each report is different. The reports combine data, charts, and natural language information, making them look like reports generated by a human being. Reports may include hyperlinks linking their sections, to make it easy to access a section that interests the user. Also, the beginning of each report also may contain a summary of the information found in more detail in other sections of the report, making it easy to jump to the other sections.

Appendix A shows an example of a report generated by asset wizard 202. Appendix B shows an example of a report generated by Oracle wizard 200. Appendix C shows examples reports generated by SQL server wizard 201. Appendix D shows an example of a report generated by performance wizard 197. Appendix E shows an example of a report generated by capacity wizard 199. Other types of reports may be generated instead of, or in addition to, the reports shown in the appendices.

As shown in Web page 196 (FIG. 26), for time-related reports, the user can select a starting date 205 and an ending date 206 for the report. Computer program 29 generates and displays a report that encompasses that time period. Pull-down menu 207 allows the user to select the device or devices about which to generate a report. Web page 196 relates to SQL server wizard 201; however, similar Web pages are provided for the other wizards shown in FIG. 26.

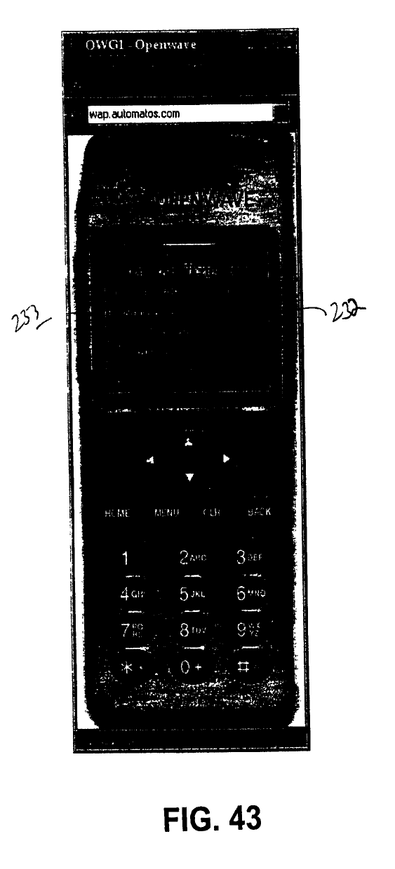

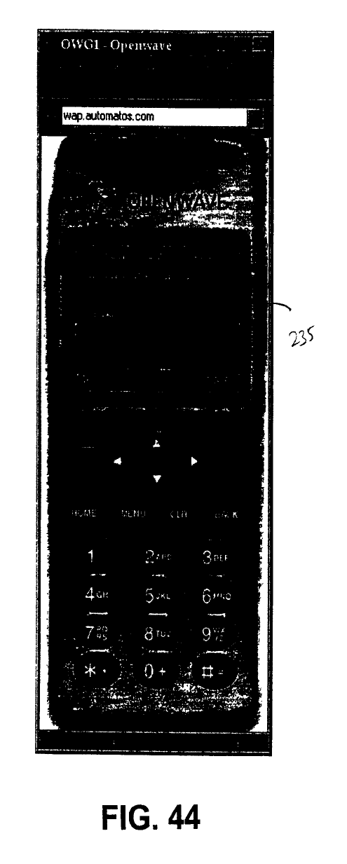

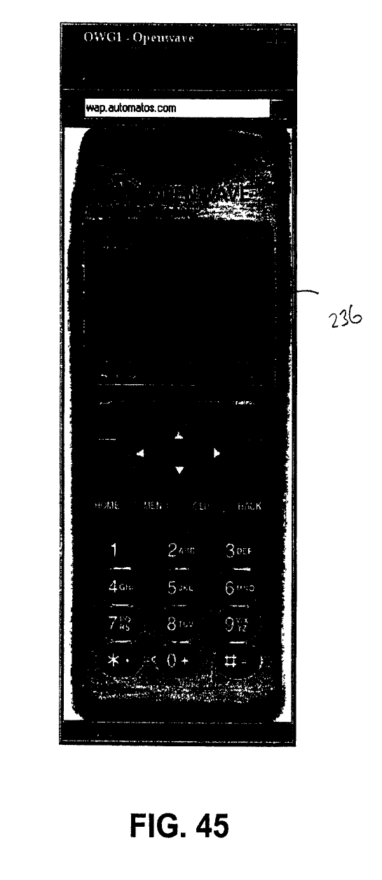

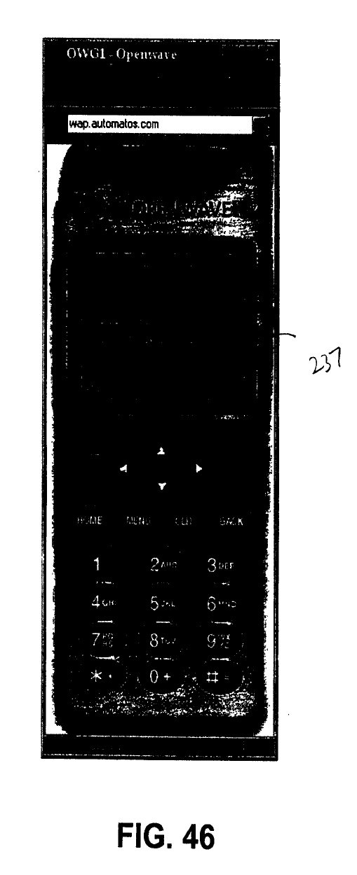

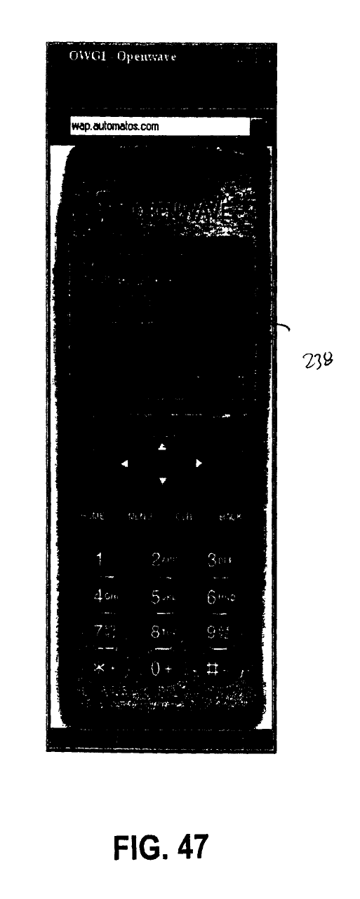

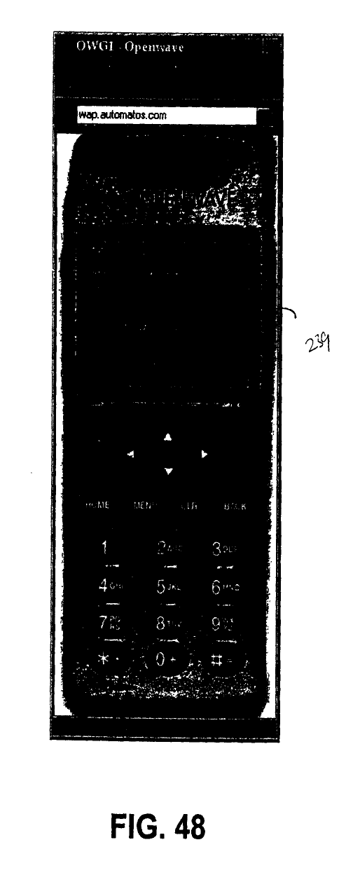

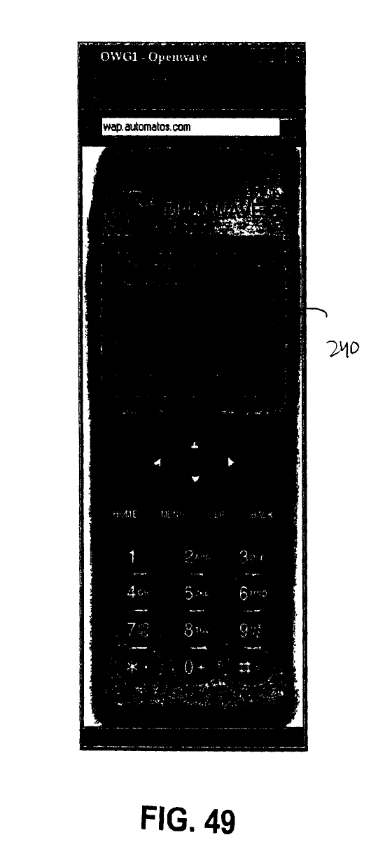

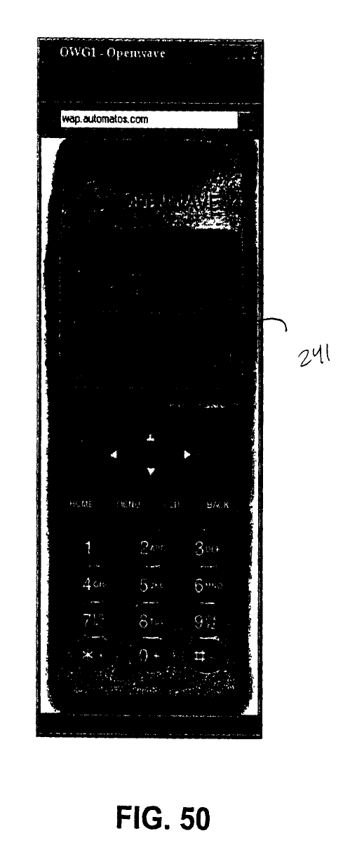

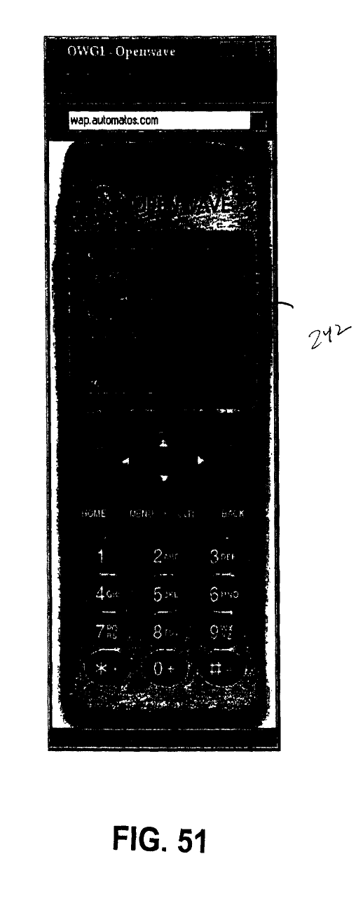

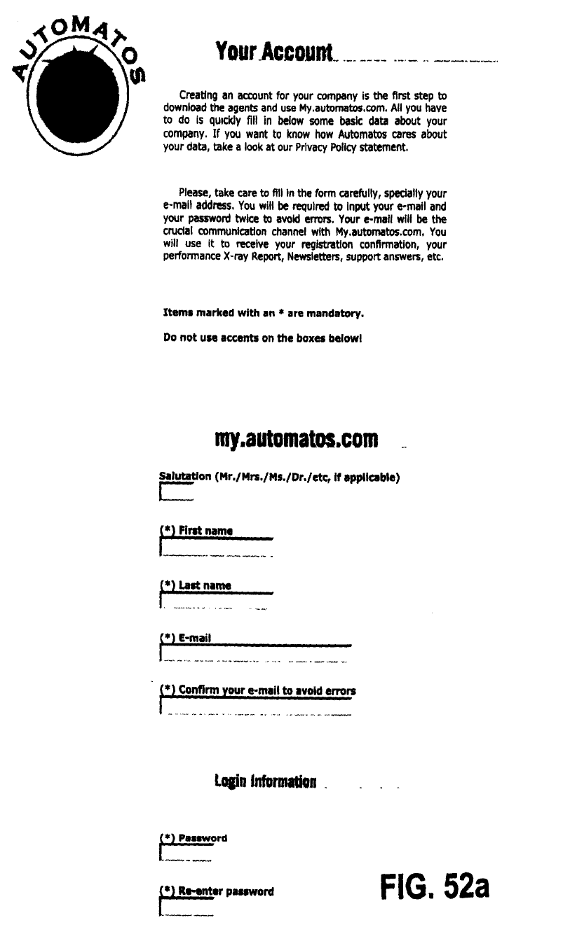

Server 21 may also transmit the device monitor data (e.g., reports, etc.) using wireless application protocol (WAP) to a wireless device, such as a cellular telephone 230 (FIG. 42). FIG. 42 shows a screen 232 for a wireless user to select the language in which to receive information. User inputs to the wireless device are likewise sent back to server 21 via WAP. FIG. 43 shows the selection of languages 233 on screen 232. FIG. 44 shows a screen 235 for the user to enter a login ID, here called an “alias”. FIG. 45 shows a screen 236 for the user to enter a password. FIG. 46 shows a screen 237 for the user to obtain a list of devices on internal network 11 for which monitoring data is available. FIG. 47 shows a screen 238 that shows the list of devices (in this example, servers). FIG. 48 shows a screen 239 which allows the user to select which features to monitor on the selected server, e.g., configuration, CPU usage, virtual memory, disk I/O, etc. FIG. 49 shows a screen 240 with the selected data, in this case, CPU usage. FIG. 50 shows a screen 241 with the selected data, in this case, virtual memory usage. FIG. 51 shows a screen 242 with the selected data, in this case, network information.

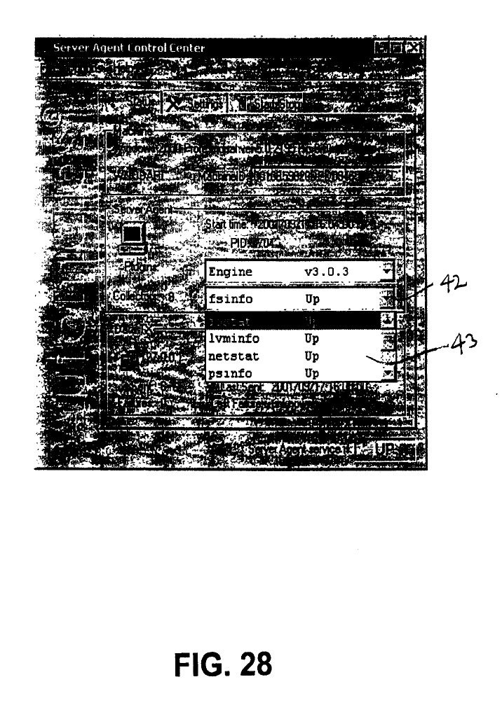

FIG. 27 shows a computer 210 on which either of processes 126 or 127 may be implemented. That is, computer 210 may represent either a device with an installed agent on internal network 11 or server 21 (FIG. 1). Computer 210 includes a processor 211, a memory 212, and a storage medium 214 (e.g., a hard disk) (see view 215). Storage medium 214 stores machine-executable instructions 216 that are executed by processor 211 out of memory 212 to perform processes 126 and/or 127.

Although a personal computer is shown in FIG. 27, processes 126 and 127 are not limited to use with the hardware and software of FIG. 27. They may find applicability in any computing or processing environment. Processes 126 and 127 may be implemented in hardware, software, or a combination of hardware and software.

Processes 126 and 127 may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform processes 126 and 127 and to generate information.

Each such program may be implemented in a high level procedural or object-oriented programming language to communicate with a computer system. However, the programs can be implemented in assembly or machine language. The language may be a compiled or an interpreted language.

Each computer program may be stored on a storage medium or other type of article of manufacture, such as a CD-ROM, hard disk, or magnetic diskette, that is readable by a general or special purpose programmable computer for configuring and operating the computer when the storage medium or device is read by the computer to perform processes 126 and 127. Processes 126 and/or 127 may also be implemented as an article of manufacture, such as a machine-readable storage medium, configured with a computer program, where, upon execution, instructions in the computer program cause a machine to operate in accordance with processes 126 and 127.

The invention is not limited to the specific embodiments described above. For example, the invention is not limited to the protocols, hardware, or software described herein. The invention is not limited to generating the specific Web pages or reports described herein. The blocks of FIGS. 10 and 11 may be reordered and/or blocks may be left out or added.

Other embodiments not described herein are also within the scope of the following claims.

What is claimed is:

1. A method, for use by an agent, of obtaining data from a device, the method comprising:
receiving a plug-in containing system calls for obtaining the data from the device;
loading the plug-in into the agent;
obtaining the data from the device using the system calls; and
transmitting the data over an external network using one or more of a plurality of protocols.

2. The method of claim 1, wherein:
the agent includes shared libraries containing system calls for obtaining other data from the device; and
the method further comprises loading the shared libraries into the agent when the plug-in is loaded.

3. The method of claim 1, wherein the data is obtained from the device periodically.

4. The method of claim 3, wherein the data is obtained every minute.

5. The method of claim 1, wherein the plurality of protocols comprises simple mail transfer protocol (SMTP), hyper text transfer protocol (HTTP), and secure sockets layer (SSL) protocol.

6. The method of claim 1, wherein data transmission is effected using at least one of a proxy and socket.

7. The method of claim 1, wherein:
the agent resides on an internal network that includes the device; and
the method further comprises selecting a machine on the internal network to transmit the data over the external network.

8. The method of claim 7, wherein the external network includes the Internet.

9. The method of claim 7, wherein the agent resides on the device.

10. The method of claim 7, wherein the agent resides on a machine located on the internal network that is not the device.

11. The method of claim 1, wherein:
the device comprises a network device located on an internal network; and
the agent resides on a server that is also on the internal network.

12. The method of claim 1, wherein the data relates to one or more of the following: a processor on the device, memory on the device, a hard drive on the device, an internal network on which the device is located, and software installed on the device.

13. A method of providing, to a client, data that was obtained by an agent from a remote device on an internal network, the method comprising:
receiving the data via an external network, at least some of the data being received periodically;
formatting the data; and
making the formatted data accessible to a client via the external network.

14. The method of claim 13, wherein formatting comprises generating a report based on the data.

15. The method of claim 14, wherein the report comprises a natural language report.

16. The method of claim 13, wherein formatting comprises:
generating a display based on the data; and
updating the display periodically as new data is received periodically via the external network.

17. The method of claim 13, wherein the data is received every minute.

18. The method of claim 13, wherein formatting comprises:
determining if the data indicates that an operational parameter of the device exceeds a preset limit; and
generating a report to a client indicating that the operational parameter exceeds the preset limit.

19. The method of claim 13, wherein the external network includes the Internet.

20. The method of claim 13, wherein making the formatted data accessible to the client comprises providing a World Wide Web site through which the data can be accessed by the client.

21. The method of claim 13, wherein the formatted data is made accessible to a wireless device using wireless application protocol.

22. A computer program stored on a machine-readable medium, the computer program comprising an agent for obtaining data from a device, the computer program comprising instructions that cause a machine to:
receive a plug-in containing system calls for obtaining the data from the device;
load the plug-in into the agent;
obtain the data from the device using the system calls; and
transmit the data over an external network using one or more of a plurality of protocols.

23. The computer program of claim 22, wherein:
the agent includes shared libraries containing system calls for obtaining other data from the device; and
the computer program further comprises instructions that cause the machine to load the shared libraries into the agent when the plug-in is loaded.

24. The computer program of claim 22, wherein the data is obtained from the device periodically.

25. The computer program of claim 24, wherein the data is obtained every minute.

26. The computer program of claim 22, wherein the plurality of protocols comprises simple mail transfer protocol (SMTP), hyper text transfer protocol (HTTP), and secure sockets layer (SSL) protocol.

27. The computer program of claim 22, wherein data transmission is effected using at least one of a proxy and socket.

28. The computer program of claim 22, wherein:
the agent resides on an internal network that includes the device; and
the computer program further comprises instructions that cause the machine to select another machine on the internal network to transmit the data over the external network.

29. The computer program of claim 28, wherein the external network includes the Internet.

30. The computer program of claim 28, wherein the agent resides on the device.

31. The computer program of claim 28, wherein the agent resides on a machine located on the internal network that is not the device.

32. The computer program of claim 22, wherein:
the device comprises a network device located on an internal network; and
the agent resides on a server that is also on the internal network.

33. The computer program of claim 22, wherein the data relates to one or more of the following: a processor on the device, memory on the device, a hard drive on the device, an internal network on which the device is located, and software installed on the device.

34. A computer program stored on a machine-readable medium for providing, to a client, data that was obtained by an agent from a remote device on an internal network, the computer program comprising instructions that cause the machine to:
receive the data via an external network, at least some of the data being received periodically;
format the data; and
make the formatted data accessible to a client via the external network.

35. The computer program of claim 34, wherein formatting comprises generating a report based on the data.

36. The computer program of claim 35, wherein the report comprises a natural language report.

37. The computer program of claim 34, wherein formatting comprises:
generating a display based on the data; and
updating the display periodically as new data is received periodically via the external network.

38. The computer program of claim 34, wherein the data is received every minute.

39. The computer program of claim 34, wherein formatting comprises:
determining if the data indicates that an operational parameter of the device exceeds a preset limit; and
generating a report to a client indicating that the operational parameter exceeds the preset limit.

40. The computer program of claim 34, wherein the external network includes the Internet.

41. The computer program of claim 34, wherein making the formatted data accessible to the client comprises providing a World Wide Web site through which the data can be accessed by the client.

42. The computer program of claim 34, wherein the formatted data is made accessible to a wireless device using wireless application protocol.
